(19) United States
(12) Patent Application Publication
(10) Pub. No.: US 2010/0138311 A1
(43) Pub. Date: Jun. 3, 2010

(54) Software Escrow Service

(76) Inventors: Stephen A. Pieraldi, San Bruno, CA (US); Scott S. Chou, South San Francisco, CA (US)

Correspondence Address: FENWICK & WEST LLP, SILICON VALLEY CENTER, 801 CALIFORNIA STREET, MOUNTAIN VIEW, CA, 94041, US

(21) Appl. No.: 12/565,615

(22) Filed: Sep. 23, 2009

Related U.S. Application Data
(60) Provisional application No. 61/099,523, filed on Sep. 23, 2008.

(51) Int. Cl. G06Q 50/00; G06Q 30/00

(52) U.S. Cl. 705/26

(57) ABSTRACT

A system and a method provide for perpetual software escrow services. A services management computer system is operated by a services management company and a trust computer system is operated by trust company. The perpetual provisioning of the software escrow service is ensured by the trust.

### CROSS-REFERENCE TO RELATED APPLICATIONS

This application claims the benefit under 35 U.S.C §119(e) of U.S. Provisional Application 61/099,523 filed on Sep. 23, 2008, which is incorporated by reference herein.

### FIELD OF THE INVENTION

The present invention relates to online digital services systems for providing digital services to consumers and more particularly to providing digital services in perpetuity, including software escrow services.

### BACKGROUND OF THE INVENTION

Consumers and businesses have a continuing need to store to an every increasing quantity of digital assets. One of the side effects of the improvements in computer performance is the explosive growth of the amount of digital media that users generate—documents, software, presentations, photographs, videos, audio recordings. The overwhelming majority of all documents created in any form today are created with computer applications, and often exist in digital form almost exclusively. In addition, many important types of documents that were once kept in paper form in secure facilities—legal documents such as wills, contracts, and so forth—are now often kept in digital form. These documents in particular need to be securely maintained for long periods of time.

Currently, there are only a limited number of options for users to store digital assets for long periods. Many users (again, including both businesses and individuals) purchase their own storage devices and associated storage media—hard drives, optical drives, CD-ROMs, DVD-ROMs, etc.—and locally store their digital assets on such devices and media. A home user, for example, may purchase a 500 Gb hard disk to have online storage all of his audio recordings, movies, copies of legal documents, and so forth. A business, for example, may purchase or lease a large system such as a 1Tb with associated optical media backups, for storing important business documents. In both of these cases, the user must both estimate their current and some future storage needs and then pay the full cost of acquiring the necessary hardware and software for this purpose. Further, because the storage needs for these users will inevitably increase over time, the user will likely have to purchase additional equipment again in the future. In addition, the user is responsible for maintaining their storage devices and taking additional steps to ensure that they devices continue to be compatible with their computers—this latter problem is especially significant since the majority of media formats become obsolete over time: consider the 8 inch, 5 inch, and 3 inch “floppy disks”. Thus, this approach thus requires a large upfront expense and repeated expenditures over time.

The primary alternative approach to purchasing storage devices is to use to an online storage service, some of which offer “free” storage, and others which charge a monthly subscription fee. The subscription services typically charge a monthly fee based on the amount of storage the user needs, with the fees increasing as the storage needs increase. The problem with subscription storage services—as with many other subscriptions—is that they becoming a continuing, and perhaps seemingly endless expense. Once a user has stored his digital assets in an online storage service, he is essentially a hostage to the service, and must continue to pay to maintain his assets. If the storage providers increase their rates, which the provider is always free to do, the user is forced to either pay the higher fees, or download his digital assets and store them at his own expense. Another problem with both subscription services is that the storage provider makes no commitment to store the user's digital assets beyond the subscription period paid for. Thus, the storage provider can, if they so choose simply refuse to provider further storage, for example by canceling the user's service agreement, or going out of business, or the like. Similarly, free storage services make no commitment whatsoever, and warn users that they may lose access to their storage digital assets at any time. Thus, online storage services also have significant downsides for users who require long term storage of their digital assets.

The need for long term storage of digital assets minors a more general requirement for users: the need for long term access to digital services generally. Digital services such as media broadcasting services (e.g., cable television, radio), network access services (e.g., internet, telephone), are typically purchased by users on a monthly subscription basis, with no long term guarantees that the services will be provided by the service provider, and with no effective way of preventing the service provider from raising the service fees over time. Similarly, users have ongoing needs for an increasing variety of digital software services, e.g., word processing, spreadsheets, accounting, presentations, graphics, data analysis, and so forth. Historically, this need has been met by users purchasing and installing software on their computers, or again by subscribing to various online software applications hosted by an application services providers. Again, the user faces both the ongoing costs of these services, and the risk that the services will not be available in the future.

### SUMMARY OF THE INVENTION

The present invention provides a computer based methods and computer systems for providing digital services, such as digital storage services, in perpetuity. In the context of the present invention, “perpetuity” and “perpetual” mean activities undertaken for the benefit of specified recipients for an ongoing, unlimited period of time and which activities are not subject to revocation, cancellation, or termination by the providers of the activities. For purposes of clarification, it should be noted that the present invention is unrelated to, and has no connection with perpetual motion machines or other any devices, systems, apparatuses that allegedly operate in a manner contrary to the laws of physics.

In one aspect of the invention, users make a single payment for a certain type or quantity digital, online services, and receive in return the right to such digital online service in perpetuity; this payment is made through a computer mediated transaction. The perpetual provisioning of the service is ensured by a trust, which is established to provide the services, and which uses a portion of the user's payment to cover the expected long term costs of the digital service, without requiring the user to pay any additional fees in the future for that particular service (though fees may be charged for other services, of course). Thus, the user obtains the desired digital online service—such as long term, online storage of digital assets—without the need for an ongoing monthly subscription fee, and without the risk that the service provider will simply decide to stop providing the services in the future. One useful, concrete, and tangible result for the user is the storage online storage of his digital assets.

One system embodiment for providing digital storage services comprises a services management computer system, such as operated by a services management company, and a trust computer system, such as operated by trust company. These computer systems are communicatively coupled over a computer network to the computer systems of third party online storage providers. Customers connect their computer systems (whether business or personal) over the network as well to the foregoing computer systems. The trust company operates a trust for the services management company, by which the trust is obligated to provide certain digital storage services to the customers. The trust company also has services agreements with the third party storage providers by which the latter agree to provide digital storage services. These third party storage providers need themselves not commit to providing perpetual storage, but do agree to provide storage for certain periods for either fixed and/or spot prices. In various embodiments, the configuration of each of these computer systems for its particular function interrelations with the other computer systems makes each such computer a specific and particularly configured machine. In addition, the coordinated operation of the services management computer system with the trust computer system creates a specific combination of machine devices.

The services management computer system provides customers with a programmatic interface by which they can enter into a customer service agreement for a particular level of digital storage or application, such as 20 Gb, 50 Gb, 100 Gb, or password vault, journal being part of a digital lifestyle suite, and so forth. For each level of digital storage or service, there is an associated single, one-time payment to be made by the customer. The amount of the payment depends on the amount of digital storage or service requested by the customer, as well as current and expected storage and code costs, expected returns on portions of the payment that are to be invested to cover such costs, and other factors including a profit component for the services management company. The amount of the payment can be determined by the trust and/or the services management company, using computer implemented funding models. This payment is made by the customer electronically via the network, to the services management company computer system. The customer's computer system is provided with a programmatic interface to the third party storage provider's computer system by which the customer can upload any digital assets to such storage systems of the third party providers. The customer's digital assets are assigned to an online storage “vault”. The trust company provides to the customer, preferably via the network, a certificate of perpetual services, by which it confirms the customer's right to have the purchased amount of digital storage maintained in the customer's vault in perpetuity. At this point, the customer's digital assets will be stored at one or more of the third party storage providers in perpetuity, and without the customer having to make any further payment for such digital storage services.

The trust company is able to ensure that the one time payment is sufficient to cover the costs for the perpetual storage of the customer's digital assets as follows. First, the underlying funding model is based on the demonstrative fact that the costs for digital storage on a per unit basis (e.g., per megabyte or per gigabyte) have always declined, and given advances in technology will continue do to so in the future. Thus, the trust company can assume that over time the costs it pays to third party storage provider for each unit of storage will decline. Based on this declining cost factor, a one-time payment can be computed as the amount to be invested at a known or assumed rate of return, so as to yield a periodic income sufficient to pay such costs. As the costs decline over time, the excess returns—the difference between the earned income from the invested one-time payment and the then current storage costs paid by the trust company to storage providers—can be used to further reduce the one-time payments required of new customers (or customer who purchase additional storage), or can be returned to the services management company as additional revenue. This funding model, and the associated costs, and resulting payments is maintained in a computer system.

Another aspect of the invention is the underlying legal arrangements between the various entities. These legal arrangements have physical manifestation in such indicia as contracts, computer-based accounts, and documents that can be persistently stored, retrieved and/or displayed. The services management company and the trust company enter into a trust agreement that includes an intellectual property (IP) transfer agreement. The IP transfer agreement transfers certain intellectual property to the trust company to enable it to provide certain core services to the customer in perpetuity. The core services include at least the providing of perpetual access to the customer's digital assets in digital storage; for purposes of reference only, this service is referred to as the core storage service. Additional services may also be defined that further extend the parties authorized to access the customer's digital assets. For example, one service allows the customer to designated certain digital assets from ever being deleted or modified; another service allows the customer to enable certain third parties to submit digital assets to the customer's vault for storage; another service allows the customer to authorize multiple recipients to access the customer's vault; and finally another service that immediately forwards the customer's storage digital assets to predetermined recipients or immediately delete such assets upon the entry of a secret code. These additional services may be provided as part of the core services, or provided for a separate fee.

The trust agreement establishes that the customers are service beneficiaries of the trust. The trust agreement grants the trust the power to provides the core services in perpetuity to both the services management company and to the customer as service beneficiaries, to license the intellectual property, to hold an invest any excess cash that results from the operations of the trust, and to distribute the excess cash to the services management company. The trust is specifically defined to be perpetual and cannot be dissolved by the services management company or by the service beneficiaries.

The services management company and the trust company also enter into an inter-company agreement. This agreement establishes the relationship and obligations between the services management company and the trust company, including how the services management company processes request from customers for digital storage services, how it pays the trust for the services provided to the customers, and specific warranties made by the trust company to the services management company regarding performance of the system, which warranties can be passed on to the customers. The inter-company agreement also licenses back the intellectual property from the trust company to the services management company so that it can operate its computer systems and business to provide the various service interfaces to the customers.

As between the customers and the services management company, each customer enters into a customer service agreement. This agreement establishes the relationship between the services management company and the customer, and defines the terms by which the services management company provides the core services to the customer, and warrants their availability. The customer service agreement further guarantees that the customer will have perpetual access to the core services. The customer service agreement allows the customer to define which users are authorized to access the customer's stored digital data.

Each customer receives a certificate of perpetual storage from the trust company, which operates as a standalone agreement between the trust company and the customer. The certificate provides the customer with the right to receive the core services from the trust company in perpetuity based upon a defined triggering condition, such as the dissolution of the services management company. The certificate further establishes that it can be transferred at will.

The trust company enters into a services agreement with one or more third party service providers. The services agreements defines the relationship between the trust company and the third party service provider, including the requirements for these third parties to provide services (e.g., storage services) for the customers, as mediated by the services management company.

Another aspect of the present invention is an online software (or more generally digital intellectual property asset) escrow service. The services management computer system enables a software developer to create a vault into which the developer stores digital assets such as software files (e.g., code, data, development documents, etc.) or other tangible forms of intellectual property. The developer can identify as other users with access rights to the vault those individuals or entities (escrow beneficiaries) for whom the software is being held in escrow, such as a business client of the developer, or any other party. The developer can define the conditions under which the escrow beneficiaries have access to the stored digital assets, using the secure activation functionality described above. The ease of setup of the digital vault, as described above, enables the software developer to have an entirely automated process for escrowing software pursuant to development or sales or other types of agreements. The developer can then provide the escrow beneficiaries with the access information, including the vault information, secret code and authentication token, so that the other party can access the escrowed software under the defined conditions. In one embodiment of the software escrow service, additional maintenance fees are charged to the developer. The services management computer system further provides methods and interfaces for a developer and escrow beneficiary to establish and negotiate the terms of an escrow contract, including the conditions and terms for release of the stored content. The services management computer system further provides methods and interfaces for an escrow beneficiary to initiate a dispute pertaining to a breach of the contract so as to obtain release of the escrowed digital assets. The developer (depositor) can also initiate a dispute in order to remove a party as an escrow beneficiary.

The features and advantages described in this summary and the following detailed description are not all-inclusive. Many additional features and advantages will be apparent to one of ordinary skill in the art in view of the drawings, specification, and claims hereof.

### BRIEF DESCRIPTION OF THE DRAWINGS

FIG. 1 is block diagram of the system architecture of one embodiment of the present invention.

FIG. 2 is a diagram of the legal arrangements between the various entities who participate in the perpetual digital services system.

FIGS. 3A-C are a sequence diagram of the overall the methodology for operating the perpetual digital services system.

FIG. 4 is an illustration of a registration and purchase webpage.

FIG. 5 is an illustration of a directory management webpage.

FIG. 6 is a data flow diagram for the operation of the financial model.

FIG. 7 illustrates example cost erosion curves as predicted by the financial model.

FIG. 8 is block diagram of the software architecture of the services management computer system.

FIG. 9 is block diagram of the software architecture of the trust company computer system.

FIG. 10 is a sequence diagram illustrating the registration process.

FIG. 11 is a sequence diagram illustrating the process of creating a membership.

FIG. 12 is a sequence diagram illustrating the process of defining directory access rights.

FIG. 13 is a sequence diagram illustrating the process of removing an existing user from accessing a vault.

FIG. 14 is a sequence diagram illustrating the process of updating the access privileges of a user.

FIG. 15 illustrates the set of directory management operations.

FIG. 16 is a sequence diagram illustrating the process of creating, deleting, and renaming folders.

FIG. 17 is a sequence diagram illustrating the process of uploading digital assets to a customer's vault.

FIG. 18 is a sequence diagram illustrating the process of downloading digital assets from a customer's vault.

FIG. 19 is a sequence diagram illustrating the process of deleting a digital asset from a customer's vault.

FIG. 20 is a sequence diagram illustrating the process of renaming a digital asset in a customer's vault.

FIG. 21A-B are a sequence diagram illustrating uploading a digital asset by email.

FIG. 22 is a sequence diagram illustrating the process of protecting a digital asset from being deleted or modified.

FIG. 23 is a sequence diagram illustrating the process of configuring a digital asset for secure destruction/activation.

FIGS. 24A-B are a sequence diagram illustrating the process of effecting the secure destruction/activation of a digital asset.

FIGS. 25-34 illustrate details of a software escrow service embodiment.

The figures depict a preferred embodiment of the present invention for purposes of illustration only. One skilled in the art will readily recognize from the following discussion that alternative embodiments of the structures and methods illustrated herein may be employed without departing from the principles of the invention described herein.

### DETAILED DESCRIPTION OF THE INVENTION

The following description and figures relate to various embodiments of the present invention by way of illustration only. One skilled in the art will readily recognize from the following discussion that alternative embodiments of the structures and methods illustrated herein may be employed without departing from the principles of the invention described herein.

Overview of the System Architecture

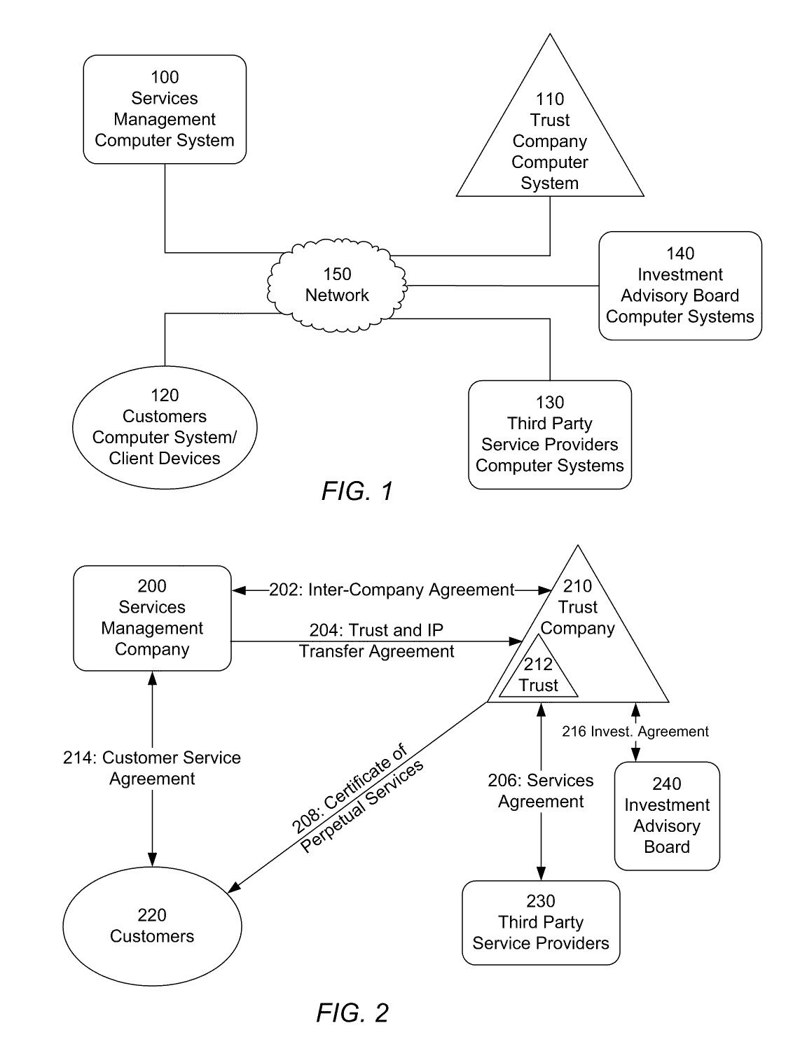

Referring now to FIG. 1, there is shown the system environment in which a system for providing perpetual digital services operates, in accordance with one embodiment of present invention. The system environment comprises services management computer system 100 operated by a services management company, a trust computer system 110 operated by trust company, a plurality of customer computer system 120 operated by customers, one or more third party service provider computer systems 130, and one or more investment advisory board computer system 140. These computer systems are communicatively coupled over a network 150, such as the Internet, using standard communications protocols and security protocols. The services management computer system 100, the trust company computer system 110, the third party service provider computer systems 130, and the investment advisory board computer systems 140 all preferably use server-class computers (e.g., high performance processors, memory, storage devices and media, and network interfaces), as readily available to those of skill in the art. These computers all support the necessary hardware and software for communication over the network 150; the network 150 includes internetworks such as any combination of the Internet, wide area and local area networks. The customer computer systems 120 can be any type of computer, including desktop or notebook computers for individual consumer customers, to enterprise-type server computers for corporate and business customers. Generally, the customer computers 120 will include a browser application for accessing the other computer systems. Again, these types of computers are readily available. This embodiment of the invention is necessarily practiced with at least the services management computer system 100 and the trust company computer system 110, which in turn operate in conjunction with customer computer systems 120.

FIG. 2 illustrates one embodiment of legal arrangements that define, coordinate, and describe the required functional and structural aspects of the various entities' computer systems. These legal arrangements have physical manifestations, for example, in contract documents and similar indicia. The services management company 200 and the trust company 210 enter into a trust agreement 204 that includes an intellectual property (IP) transfer agreement and the creation of a trust 212. The trust company 210 is the trustee of the trust 212 for the services management company 200. The trust agreement 204 establishes that the customers 220 are service beneficiaries of the trust 212. The trust 212 is specifically defined to be perpetual and cannot be dissolved by the services management company 200 or by the service beneficiaries (i.e., the customers 220).

The IP transfer agreement transfers certain intellectual property to the trust company 210 to enable it to provide certain core services to the customers in perpetuity. The trust agreement 204 then empowers the trust company 210 to provide the core services to the customers 210. Specifically, the trust agreement 204 grants the trust 212 the power to provides the core services in perpetuity to both the services management company 200 and to the customer 220 as service beneficiaries, to license the intellectual property (including software, hardware, and technical information), to hold and invest any excess cash that results from the operations of the trust 212, and to distribute the excess cash to the services management company 200. The trust company 210 is further obligated to provide, via use of the third party storage provider computer system 130, digital storage services to the customers 220 for storing the digital assets of the customers 220.

The trust company 210 has services agreements 206 with the third party storage providers 230 by which the latter agree to provide the digital storage services to the customers and/or to the trust company 210. These third party storage providers 230 need themselves not commit to providing perpetual storage, but do agree to provide storage for certain periods for either fixed and/or spot prices.

The services management company 200 and the trust company 210 also enter into an inter-company agreement 202. This agreement establishes the relationship and obligations between the services management company and the trust company, including how the services management company 200 processes request from customers 220 for digital storage services, how it pays the trust company 210 for the services provided to the customers 220, and specific warranties made by the trust company 210 to the services management company 200 regarding performance of the system, which warranties can be passed on to the customers 220. The inter-company agreement 202 also licenses back the intellectual property from the trust company 210 to the services management company 200 so that it can operate its computer systems 100 and business to provide the various service interfaces to the customers in accordance with the overall design of this invention. In this way the services management company 200 is responsible to locate customers and provide them access to the core services provided exclusively from the trust company 210.

As between the customers 220 and the services management company 200, each customer enters into a customer service agreement 214. This agreement establishes the relationship between the services management company 200 and the customer 220, and defines the terms by which the services management company 200 provides the core services to the customer 220, and warrants their availability in perpetuity. The customer service agreement 214 further guarantees that the customer will have perpetual access to the core services. The customer service agreement 214 further confirms that that the customer is a service beneficiary of the trust 212, and that if the services management company 210 ceases to exist, the trust 212 will be available in perpetuity to provide the customer with access to his digital assets. The customer service agreement 214 allows the customer to define which users are authorized to access the customer's stored digital data. The customer is assigned a digital storage “vault”, a portion of a computer storage system in which the customer will store their digital assets.

The trust company 210 provides to the customer 220, preferably via the network 140, a certificate of perpetual services 208, which operates as a standalone agreement between the trust company 210 and the customer 220. The certificate 208 provides the customer 220 with the right to receive the core services from the trust company 210 in perpetuity based upon a defined triggering condition, such as the dissolution of the services management 200 company. The certificate 208 further establishes that it can be transferred at will. Thus, the customer 220 can sell, assign or license his perpetually stored digital assets to another party, or transfer them in a will, estate or other mechanism to his heirs or others. The certificate 208 is embodied in a document or other persistently stored object, such as a computer file.

The trust company 210 enters into a services agreement 206 with one or more third party service providers 230. The services agreements 206 define the relationship between the trust company 210 and the third party service providers 230. More particularly, the third party service providers 230 agree to provide digital services, here storage and access services, to the customers 220 via the services management company 200 and the trust company 210 The services agreement 206 defines the price structure that the trust company 210 will pay for the storage, as well as conditions for changes in such prices. The service agreement 206 also defines various operational requirements, such as uptime, quality of service, system compatibility and so forth.

Finally, the trust company 210 enters into an investment advisory agreement 216 with investment advisory board 240. The agreement gives the board 240 the authority to provide advice and recommendations to the trust company 210 for investing any excess cash of the trust company 210 resulting from its operations. This ensure that the trust company 210 responsibly manages the underlying assets of the trust, so as be able to fully fund the ongoing expenses for storing the customers' digital assets.

Overview of Method of Operation

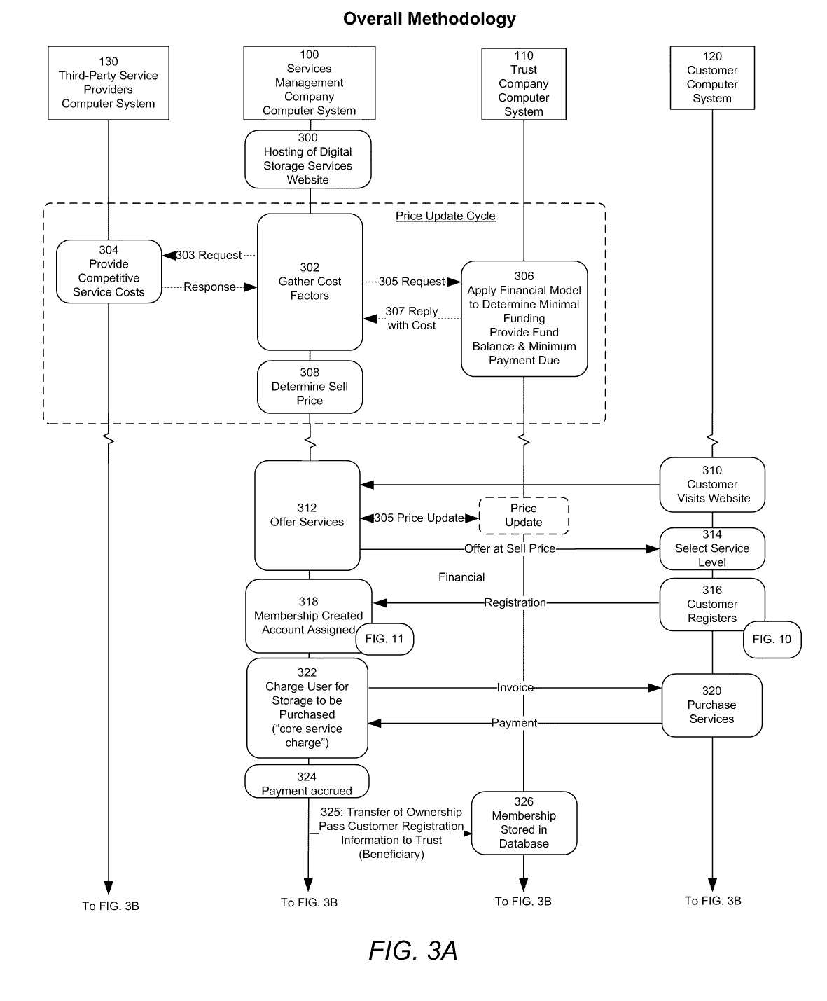

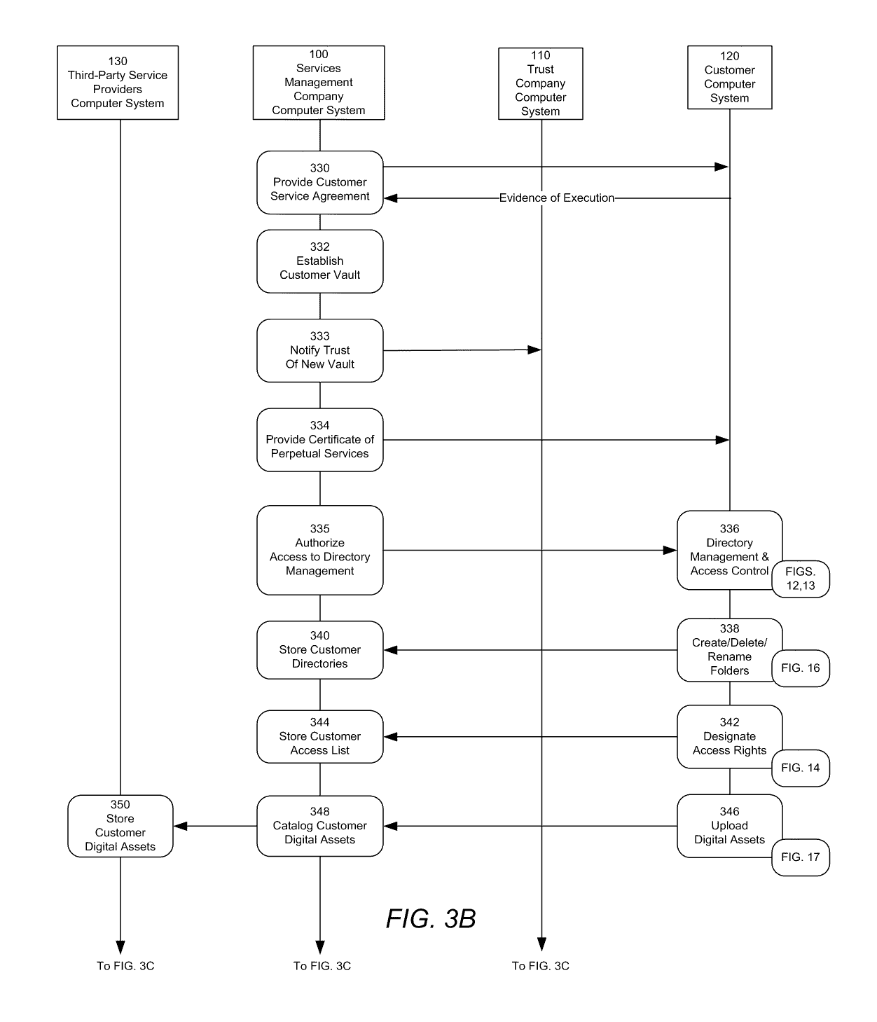

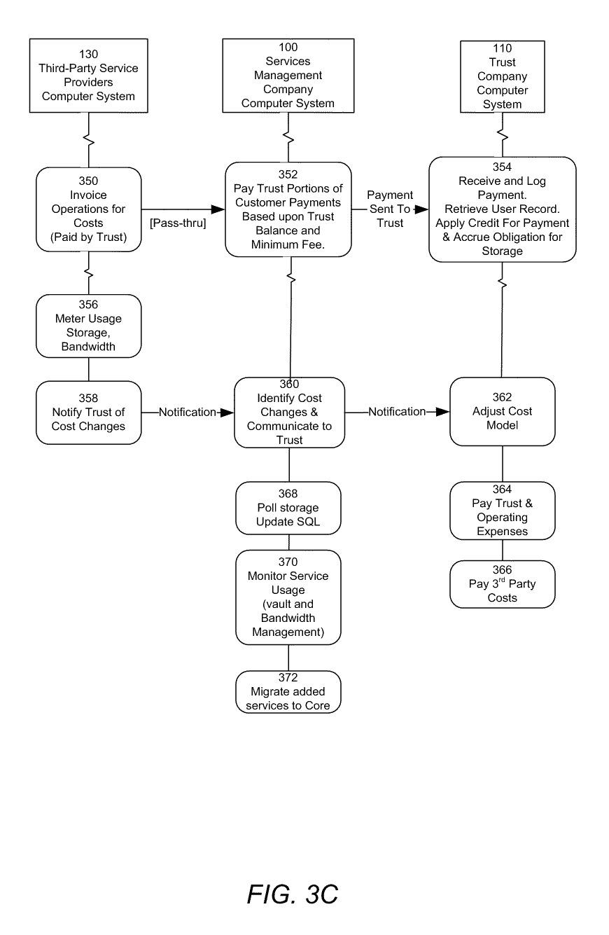

Referring now to FIGS. 3A-3C there is shown a sequence diagram of the overall the methodology for operating the perpetual digital services system.

As a prior condition, the various agreements between the services management company 200, the trust company 210, the third party storage providers 230, and the investment advisory board 240 are assumed to be in place.

The services management computer system 100 hosts 300 a website using a web server which serves web pages to the customer computer system 120 (e.g., to the browser application thereon). Via this website, the services management company 200, on behalf of the trust company 210, offers to the customers 220 a list of a plurality of different levels of digital storage, such as 20 Gb, 50 Gb, 100 Gb, and so forth. These levels are referred to as storage allotments. For each storage allotment, there is an associated bandwidth allotment, which is a measure of how much bandwidth the customer is allowed per month (e.g., uploads or downloads in terms of byte amount). The offering may be communicated in other terms, such as a number of documents, digital images, or other types of files that can be stored at each level; for example, a basic level may be communicated as 20 Gb or 40 images, 150 PDF files, or 400 word processing files. This offer is communicated to the customers via one or more webpages, as will be described below.

The services management computer system 100 performs a price update cycle to determine the sell price for the storage allotments. During this cycle, the services management computer system 100 obtains 302 a set of costs factors for determining the various one-time fees to be associated with each storage allotment, and to be paid by the customers 220. More specifically, for each storage allotment (and associated bandwidth allotment), there is an associated single, one-time payment; this payment is to be made by the customer 220 to the services management company 200. To obtain the cost factors the services management computer system 100 can use locally stored costs factors that it has previously received from the trust company 210 and from the storage providers 230. In one embodiment, the services management computer system 100 can make a real time request 303 to one or more of the third party storage provider(s) computer system 130. Each requested third party storage provider computer system 130 responds with a current price for the customer's requested amount of storage based on any prior agreement (e.g., the service agreements 206) or other factors (e.g., current demand). Where there is only one such third party storage provider computer system 130, the services management computer system 100 benefits from having the most up to date cost factors. Where there are multiple third party storage provider computer systems 130, each providing a storage cost estimate, the services management computer system 100 is then able to select the most favorable of these costs factors, typically the lowest per unit cost. The services management computer system 100 may also make a real time request 306 to the trust company computer system 110 to obtain a funding cost for funding the storage costs (and bandwidth costs) for the customer's requested storage allotment and associated bandwidth allotment, based on its financial model. The trust company computer system 110 executes 306 its financial model using its current data on storage cost, utilization rates, rates of return, and so forth to produce a final cost, which is communicated as reply 307 to the services management computer system 100. The services management computer system 100 then determines 308 a sell price for each storage allotment, as the one-time payment for the request amount of digital storage. This sell price can include charges for additional services provided by the services management computer system 100, as well as a profit component, and other costs and surcharges for regulatory, governmental or other purposes. This sell price will be provided to the customer's computer system 120, for example via an on-screen presentation, as further described below. This price update cycle can be repeated at any later time.

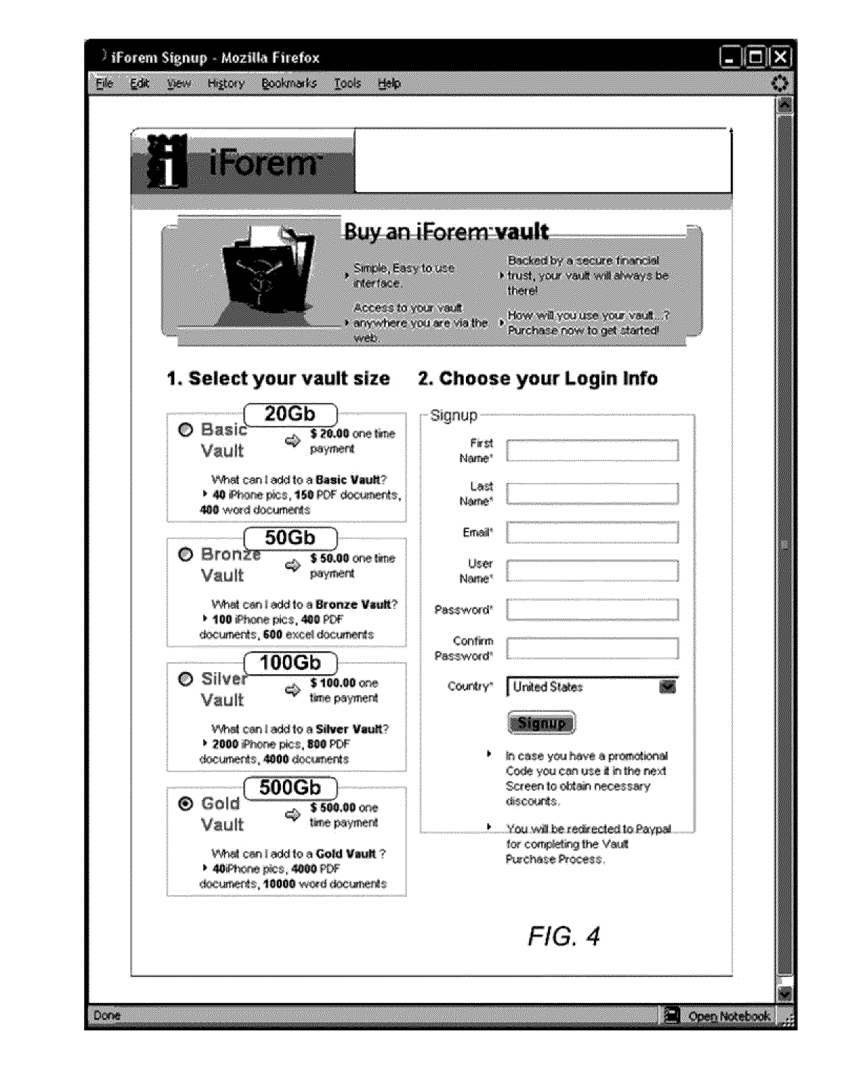

At some point in time the customer, using their computer system 120 accesses 310 the services management company's website. The website presents the offer 312 of services, from which the customer can select the appropriate level of services, along with a form for registration. As part of the offer 312 process, the services management computer system 100 may make a real time request 305 for a price update to the trust company computer system 110. FIG. 4 illustrates an example webpage communicating the offer of the various service levels, here storage allotments, as described in terms of both storage amount (e.g., 20 Gb) and equivalent capacity (e.g., 100 documents) and registration form. Using this web page the customer makes the selection 314 of desired storage allotment. The customer then registers 316 for an account, providing account information such as name and address, contact information and the like. The customer may also enter a name that will be applied to their storage allocation. The services management computer system 100 creates 318 a membership account for the customer, and stores this information in its own internal database. The customer also provides payment information such as credit card number, debit card, or other financial account information. The customer then confirms the selected services and authorizes 320 the payment for purchasing the digital storage service. The services management computer system 100 receives the user's credit card number (or other payment means) and charges 322 the customer, obtaining an approval from a third party payment service. The services management computer system 100 then accrues 324 the payment in its accounting system, and updates the appropriate accounting and payment files. The services management computer system 100 also transfers 325 an indication of ownership of the customer registration to trust company computer system 110, which stores 326 the customer registration in its database. At this point, the customer is a service beneficiary of the trust agreement 214.

Referring now to FIG. 3B, the services management computer system 100 transmits 330 a copy of the customer service agreement 214 to the customer's computer system 120, with instructions for the customer to execute the document electronically, e.g., by selection of a on-screen dialog indicating acceptance of the terms. The services management computer system 100 can also send a separate email (or provide a link to a page) containing a user manual. The services management computer system 100 then creates 332 a digital storage vault for the customer corresponding to the customer's purchased storage allotment. The vault serves as the catalog for all of the customer's digital assets, and is given the name provided by the customer previously. To create the vault, the services management computer system 100 creates an entry in its database with the customer's member ID, and data identifying the storage allotment purchased by the customer. A vault log file is created for the customer, which will store a running history of the customer's accesses to their vault. The services management computer system 100 internally logs the creation of the customer's vault as well, for its own record keeping, thereby booking its storage obligation to the customer. The services management computer system 100 then notifies 333 the trust company computer system 110 of the newly created vault for the customer; the trust company computer system 110 updates its own database with this information (e.g., vault name, size). The trust company computer system 110 books this newly created storage vault as a storage obligation that has to be funded.

The services management computer system 100 also creates an instance of the certificate for perpetual services 208 and transmits 334 a copy (e.g. a digital file, such as a PDF document) of this certificate to the customer's computer 120, where the customer can store it for future reference. The creation and transmission is logged by the services management computer system 100 as well.

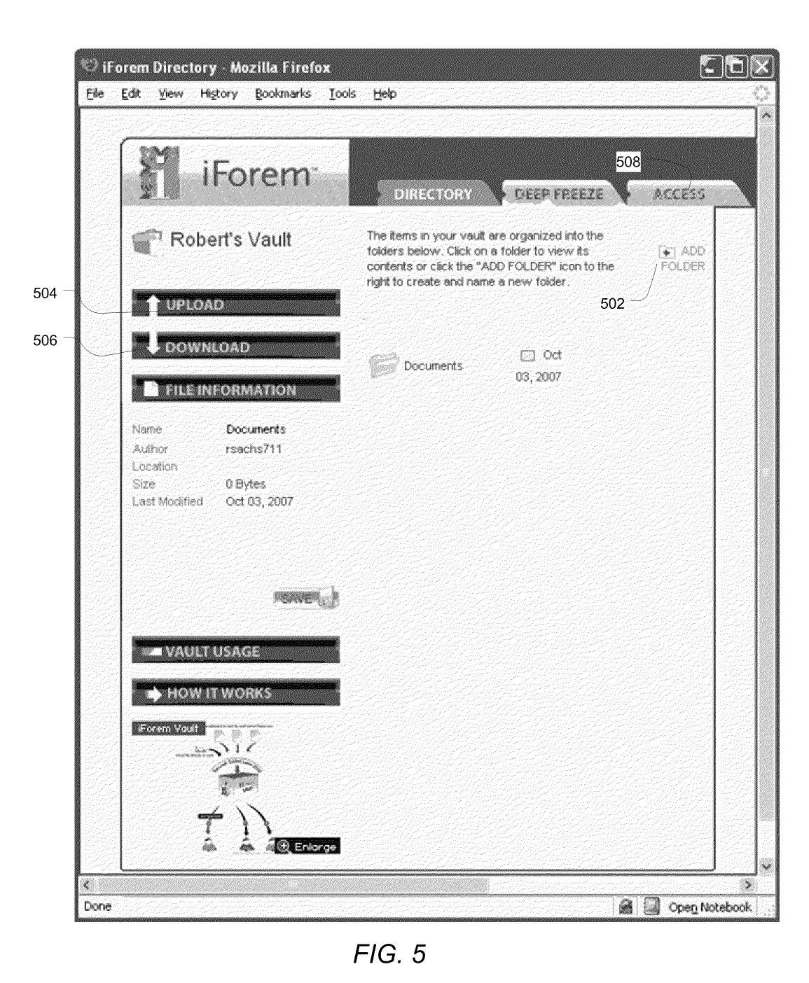

The services management computer system 100 authorizes 335 the customer's computer system 120 to access a directory and management access control interface 336, so that the customer can access their vault. Using this programmatic interface, the customer creates 338 one or more folders (directories) for organizing their digital assets; the customer can also delete and rename folders via this interface. FIG. 5 illustrates an example of a web page providing a user interface (which accesses the underlying programmatic interface of the system 100) for managing folders (add a folder button 502) and file uploads (upload button 502), downloads (download button 506) and other services.

The customer can also edit their membership information (e.g., changing address, password, etc.; this can be done at any time). The customer then defines 342 which other users (if any) have access rights to the digital assets (FIG. 5, access tab 508). The customer's directory information and access control list information is stored 340, 344 at the services management computer system 100. The customer then uses the programmatic interface to upload 346 (FIG. 5, “Upload” button 502) their digital assets to the services management computer system 100, to a directory selected by the customer. The services management computer system 100 catalogs the digital assets into the customer's vault and directory, assigning each file (or group of files) a unique file identifier. The services management computer system 100 then provides, e.g., via a controlled session channel, the customer's digital asset file to the third party storage provider computer 130, where it is stored 350. At any time the customer can return to the website of the services management company 100 and access their account, including any of creating/editing/deleting folders, and modifying access rights, and uploading additional digital assets, downloading assets, or deleting previously uploaded assets. The process steps of purchasing digital storage and the creation of a vault for the customer's selected storage allotment may be repeated multiple times by a customer, so that the customer can purchase multiple vaults, each with different storage allotments and access control lists. In addition, access control lists and storage allotments can be added to on demand by the customer.

Referring now to FIG. 3C, there is a further sequence diagram of the process by which the services management computer system 100, trust company computer system 110, and third party service provider computer system(s) 130 interact to manage the financial and other aspects of the system operation. At some point in time (asynchronous to the events in FIGS. 3A-3B) the third party service provider 230 will issue 350 (via its computer system 130) an invoice for the storage usage being made of its system. This invoice will typically be generated on a monthly basis. The invoice is transmitted to the services management computer system 100, where it is logged into an accounting system, before being passed through to the trust company computer system 110.

The services management computer system 100 aggregates the customer payments received for new customers and pays 352 a portion of these payments to the trust company (e.g., by wire transfer, ACH transfer, SWIFT, or the like), sending acknowledgement of payment to the trust company computer system 110. The portion of each customer's payment that is paid to the trust company 110 is based on the minimum fee indicated by the trust company 210 at time the customer requested services. The trust company computer system 110 logs 354 the payment, and updates the customer's account record to show that payment for the requested storage has been received and credited. The trust company computer system 110 further accrues at this point the financial obligation for paying for the perpetual storage of the various customers' digital assets.

The storage provider computer system 130 is also configured by the storage provider to monitor 356 the usage of its storage and bandwidth. This includes monitoring all incoming and outgoing accesses (read/writes of data), including both file and message lengths, so as to maintain an ongoing record of storage and bandwidth usage. These metrics are aggregated for individual customers (to ensure compliance with each customer's storage allotment) and across customers (for monitoring overall usage). The storage provider computer system 130 notifies 358 the trust company computer system 110 (via the services management computer system 100) of changes in the costs for storage. The services management computer system 100 processes the cost information to identify the cost changes, and transfers 360 this information to the trust company computer system 110. The services management computer system 100 also determines 368 the current storage usage, which is used for forecasting the storage and bandwidth utilization in the financial model 600. The services management computer system 100 further monitors 370 is service usage, in terms of storage and bandwidth consumed. This information is also used for modeling the estimated storage requirements, and costs. Finally, as additional services are developed, these are migrated 372 into the core services.

The trust company computer system 110 adjusts 360 the underlying financial model used for determining the storage costs. The trust company computer system 110 is further configured to make payments (e.g., wire transfers) for the operating and trust expenses, as well as payments 366 for third party costs.

Financial Model

The trust company 210 is able to ensure that the one time payment is sufficient to cover the costs for the perpetual storage of the customer's digital assets by using a financial model that determines the amount of funding necessary for any given requested amount of digital storage. First, the underlying funding model is based on the demonstrative fact that the costs for digital storage on a per unit basis (e.g., per megabyte or per gigabyte) have always declined, and given advances in technology will continue do to so in the future. Thus, the trust company 210 can assume that over time the costs it pays to third party storage provider 230 for each unit of storage will decline. Based on this declining cost factor and others, a one-time payment can be determined as the amount to be invested at a known or assumed rate of return, so as to yield a periodic income sufficient to pay such costs. As the costs decline over time, the excess returns—the difference between the earned income from the invested one-time payment and the then current storage costs paid by the trust company 210 to the storage providers 230—can be used to further reduce the one-time payments required of new customers (or customers who purchase additional storage), or can be returned to the services management company 200 as additional revenue.

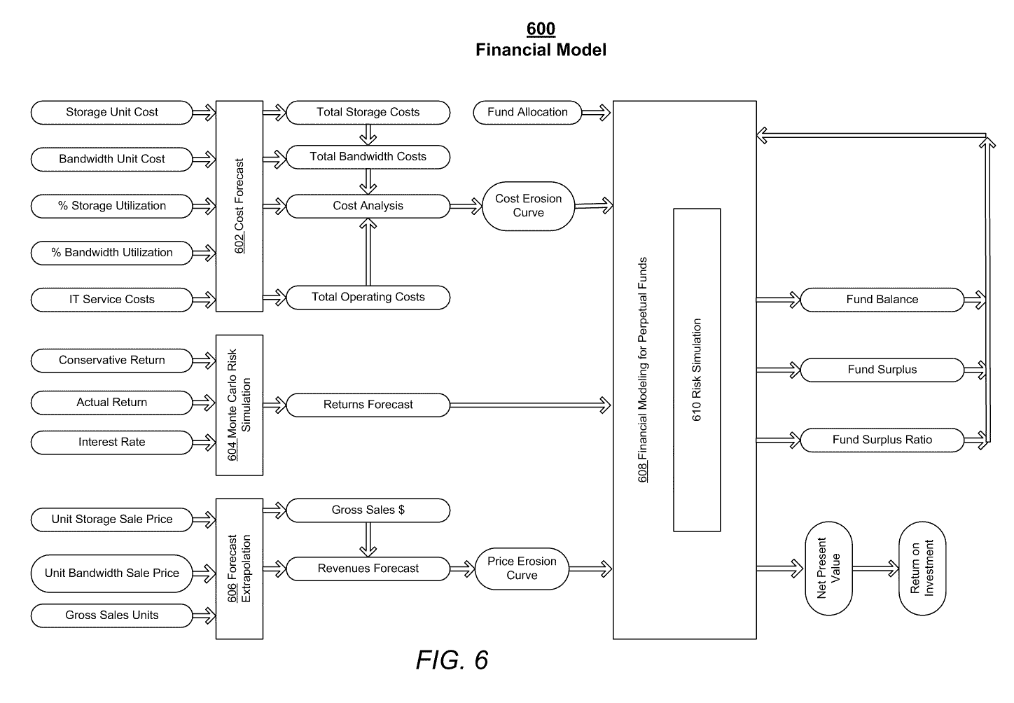

FIG. 6 illustrates the overall data flow for one embodiment of a financial model 600. The financial model 600 comprises several underlying models: a cost forecast model 602, a risk simulation model 604, a revenue forecast model 606, and a trust funding model 608. These models are created, stored, and manipulated in a computer system, such as the trust company computer system 110.

The cost forecast model 602 takes as inputs the following information:
Storage Unit Cost: the amount per unit of storage (e.g., Mb), either actual or estimated that the trust company 210 will have to pay, per period (e.g. monthly) for a selected projection interval (e.g., 60 months).
Storage Usage Level: the percentage of total storage that is utilized in a given period.
Bandwidth Unit Cost: the amount per unit of bandwidth (e.g., Mb/s), either actual or estimated that the trust company 210 will have to pay, per period (e.g. monthly) for the projection interval.
Bandwidth Usage Level: the percentage of total bandwidth that is utilized in a given period.

For each of the foregoing factors, three values are specified for each period: an assumed/actual amount, a maximum, and a minimum. Tables 1-4 below illustrate examples of a cost forecast model 602:

TABLE 1
Storage Unit Cost
Assumed

| Months | Cost | Min | Max |
|---|---|---|---|
| 1 | $0.15 | $0.14 | $0.16 |
| 6 | $0.14 | $0.13 | $0.15 |
| 12 | $0.13 | $0.12 | $0.14 |
| 18 | $0.12 | $0.11 | $0.13 |
| 24 | $0.10 | $0.09 | $0.11 |
| 30 | $0.11 | $0.10 | $0.12 |
| 36 | $0.10 | $0.09 | $0.11 |
| 42 | $0.09 | $0.08 | $0.10 |
| 48 | $0.08 | $0.07 | $0.09 |
| 54 | $0.07 | $0.06 | $0.08 |
| 60 | $0.06 | $0.05 | $0.07 |

TABLE 2
Storage Usage Level
Assumed

| Months | % | Min | Max |
|---|---|---|---|
| 1 | 50% | 40% | 60% |
| 6 | 50% | 40% | 60% |
| 12 | 50% | 40% | 60% |
| 18 | 55% | 45% | 65% |
| 24 | 55% | 45% | 65% |
| 30 | 60% | 50% | 70% |
| 36 | 60% | 50% | 70% |
| 42 | 60% | 50% | 70% |
| 48 | 60% | 50% | 70% |
| 54 | 60% | 50% | 70% |
| 60 | 60% | 50% | 70% |

TABLE 3
Bandwidth Unit Cost
Assumed

| Months | Cost | Min | Max |
|---|---|---|---|
| 1 | $0.25 | $0.24 | $0.26 |
| 6 | $0.25 | $0.24 | $0.26 |
| 12 | $0.24 | $0.23 | $0.25 |
| 18 | $0.24 | $0.23 | $0.25 |
| 24 | $0.23 | $0.22 | $0.24 |
| 30 | $0.23 | $0.22 | $0.24 |
| 36 | $0.22 | $0.21 | $0.23 |
| 42 | $0.20 | $0.19 | $0.21 |
| 48 | $0.18 | $0.17 | $0.19 |
| 54 | $0.16 | $0.15 | $0.17 |
| 60 | $0.14 | $0.13 | $0.15 |

TABLE 4
Bandwidth Usage Level
Assumed

| Months | % | Min | Max |
|---|---|---|---|
| 1 | 50% | 40% | 60% |
| 6 | 50% | 40% | 60% |
| 12 | 50% | 40% | 60% |
| 18 | 55% | 45% | 65% |
| 24 | 55% | 45% | 65% |
| 30 | 60% | 50% | 70% |
| 36 | 60% | 50% | 70% |
| 42 | 60% | 50% | 70% |
| 48 | 60% | 50% | 70% |
| 54 | 60% | 50% | 70% |
| 60 | 60% | 50% | 70% |

The cost forecast model 602 can take a limited number of the above values (e.g., values for each six month interval, as shown) and interpolates the intermediate (e.g., monthly) values. The output of the cost forecast model 602 are total cost estimates over the projection interval for the following values:

Total Storage costs; and

Total Bandwidth costs.

For each of these costs, there is a projection of both a fully loaded cost (assuming complete, 100% utilization by each of customer of their allocated storage and bandwidth), and used costs based on the utilization estimates. These costs are per month, over the projection interval.

An additional cost component that can be extrapolated are the total operating costs to the services management company and the trust company 210 for ongoing monthly costs. These costs include call center support for a call center to service customer inquiries; new product development, customization of specific services and interfaces for particular customers (e.g., corporate customers); data migration for storage upgrades; server maintenance; bug fixes of server software; migration of new services to core services.

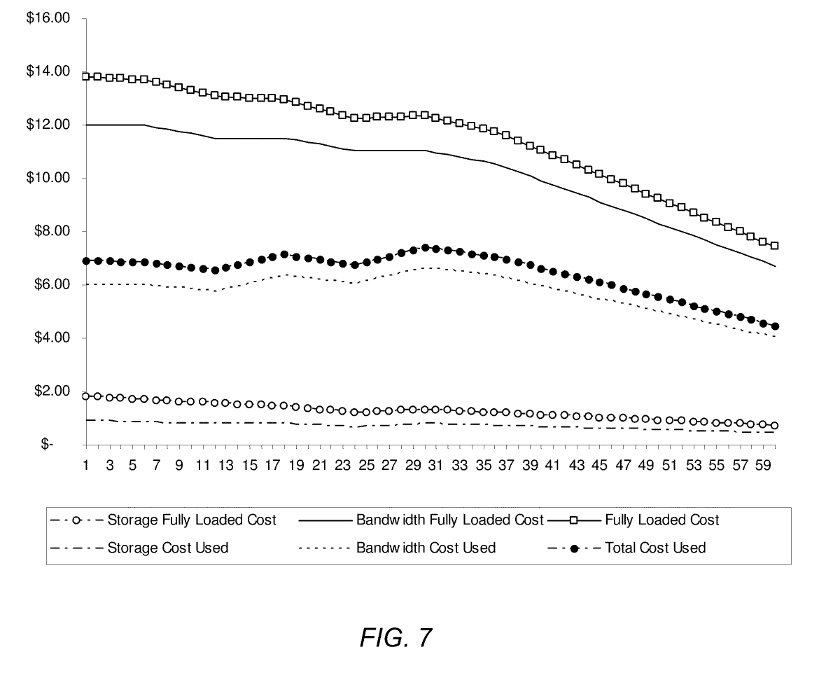

These various cost projections provide a set of cost erosion curves. FIG. 7 illustrates an example of the cost estimates from the cost forecast model 602, using the above inputs in Tables 1-4.

A second component of the financial model 600 is the risk simulation model 604. The risk simulation model 604 is a Monte Carlo simulation of interest rates per period over the projection interval. The inputs to the risk simulation model 604 are a target conservative rate of return, an actual rate of return, and a set of current interest rates. The outputs are two sets of both of estimated interest rates for each month of the projection interval, one set which clusters around the conservative rate of return, and a second set which clusters around the current rates of return. These interest rates are used in the funding model 608.

A third component of the financial model is the revenue forecast model 606. The inputs to the revenue forecast model 604 include:
Unit storage sales price: the price per unit of storage as charged to the customers for storage of the digital assets;
Unit bandwidth sales prices: the price per unit of bandwidth charged to the customers for access to the stored assets;
Cumulative sales units: the total number of units of storage expected to be sold during the projection period, cumulatively per month.

The output of the revenue forecast model 606 includes:
Gross sales in dollars: total sales per month based on unit price, and estimated volume of units sold;
Price erosion curve: this is a monthly revenue forecast: gross revenue based on gross and total costs. These curves show the projected decline in the prices charged to customers over the projection period. As the costs decline, the prices will also decline, but at a somewhat slower rate.

The outputs of the cost forecast model 602, the risk simulation model 605 and the revenue forecast model 606 are input into trust funding and valuation model 608. This model determines the amount of funds that need to be allocated to the trust to ensure sufficient funds to cover the costs of providing the services in perpetuity, given all of the current inputs. The inputs to the trust funding model 608 are:
The cost and price erosion curves described above; and
Fund allocation percentage: monthly percentage allocation of the funds received from the services management company that can be contributed to the fund for investment to cover the costs. For example, for each month, some percentage of the funds received, such as 60%, are allocated to a trust fund that will be invested to cover the storage and bandwidth costs for the storage purchased that month.

As part of the trust funding process, a second Monte Carlo simulation is run on the cost and price erosion curves, varying these values around their assumed values, within their minimum/maximum ranges.

The outputs of the trust funding model 608 are the following:
Fund balance: the total amount held in the fund, per month, based on that month's costs, prices, estimated rates of return;
Fund surplus: the fund surplus is the amount over what is needed for fund, based on actual experience of costs and prices. As the surplus increases it will reach a level which allows the sales prices to be reduced. Typically, this is done at the point that the surplus is at least 30% above total operating expenses.
Fund surplus ratio: Generally, this is the ratio of total operating income to total operating costs. In one embodiment, it is the ratio of total value available in the fund to the total required amount to fund all operating costs in perpetuity at specific points in time.

For each month of the projection, a large number of simulated outputs values (e.g., 5,000 to 15,000) are determined for each output variable. Confidence interval at 90%, 95%, and 99% are established. In order to ensure that the fund allocation percentage is sufficient, the fund surplus at the 99% right-tail confidence interval should be positive. The confidence interval obtained from a risk simulation is used to ensure that all uncertainties that can affect the fund requirements are accounted for in the model. If it is not positive, then the fund allocation is increased, and the trust funding and valuation model 608 is run again. In addition, the fund surplus ratio, at the 99% confidence interval should range between 1.3 and 1.5. If the fund surplus ratio is less than 1.3, the fund allocation percentage is increased; likewise if the fund surplus ration is above 1.5, then the fund allocation percentage is decreased. In sum, the fund allocation percentage is set so that the fund balance is positive and the fund surplus ratio is between 1.3 and 1.5, both at the 99% confidence level.

The trust funding model 608 further computes the net present value of the fund and the services management company's operations (based on the income surplus and business operating costs), as well as a return on investment for both the fund and the company's operations.

The financial model 600 is recomputed at specified periodic intervals, for example, monthly or quarterly, whenever any changes in the fund allocation percentage are made or if there are substantial changes in the input assumptions such as shifts in storage and bandwidth costs. The then current cost and price erosion curves as well as the existing fund surplus, fund balance, fund surplus ratio are re-input as well.

Detailed System Architecture

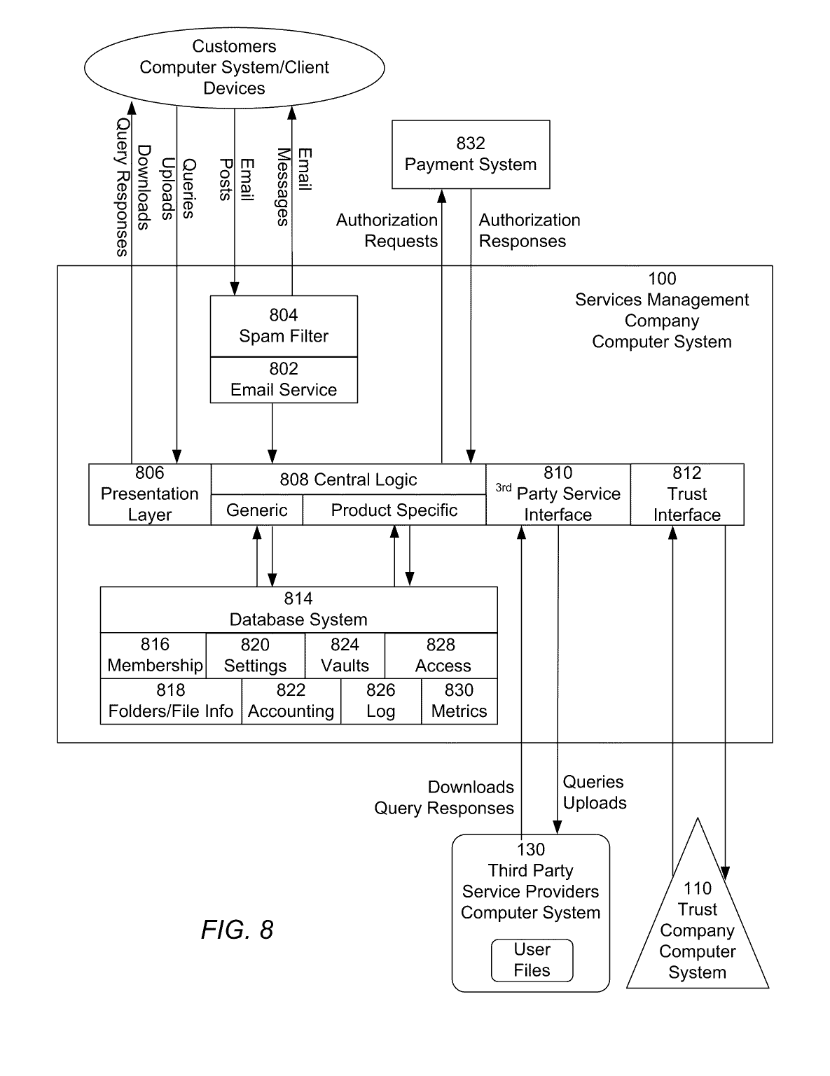

Referring now to FIG. 8, there is shown in more detail the system architecture of the services management computer system 100. This system comprises the following functional modules. Those of skill in the art of system architecture design will appreciate that various standard modules, such as security, backup management, network operations, failover, accounting, and so forth are not shown so as to not obscure the relevant details of the embodiment. Similar, standard hardware and software elements, such as load balancers, firewalls, network switches, and the like are not shown in order to avoid obscuring the description of the system.

The presentation layer 806 provides the interface for the customer computer systems 120, generally by serving web pages and related code (e.g., JavaScript) and media (e.g., Flash). The presentation layer 806 receives queries and uploads from a customers system 120, and provides query responses and also downloads of digital assets to a customer system 120.

The central logic 808 provides the functional operations described above with respect to FIGS. 3A-3C, including generic functional operations, such as account registration, purchasing, payment processing and the financial modeling, and product specific functional operations, such as directory management, access management, and file management. The central logic 808 includes application programming interfaces to a third party payment system 832, by which it can make requests for authorization of payments, and receive responses; the third party payment system 832 can be an automated clearing house (e.g., credit cards, ACH, POS). The central logic 88 also interfaces with an email service 802 for sending emails to, and receiving emails from, customer computer systems 120. An anti-spam filter 804 is used to filter out spam messages.

The third party service interfaces 810 enable communication between the services management computer system 100 and the third party storage provider computer systems 130, for queries, uploading customer's digital assets, and downloading customer digital assets as well. The queries include queries pertaining to storage costs of the third parties, as well as queries about customer account status, storage and bandwidth utilization, service capabilities, and the like.

The trust interface 812 is an application programming interface that enables communications with the trust company computer system 110, including providing information regarding new customers, establishing customer accounts, making and receiving requests for costs and funding information, updating cost factors, and the like.

The database management system 814 provides database facilities for the services management computer system 100. The database 814 includes membership 816 tables and functions for establishing and managing customer accounts. A setting table 820 defines the particular policies and default settings each customer's account. A vaults table 824 stores a table of the vaults, including their status, such as active, closed, pending, and so forth, with identification information identifying the customers and users associated with each vault, as well as related parameters, such as the storage allocation for the vault, the additional services (if any) associated with the vault, and so forth. Access control rules table 828 are tables that define the access rules for each customer's vault, including the user's that are authorized to access the vault, and their access privileges. Folders/file table 818 stores the current directory structure for each customer's vault. Accounting table 822 stores accounting information for each customer (accounts receivable) and vendor/storage provider (accounts payable). Log tables 826 are used to log events and activities that take place in each customer's vault. Metrics table 830 stores historical and current information as to storage and bandwidth utilization, customer accesses, and other measures of performance and operations for the services management computer system 100.

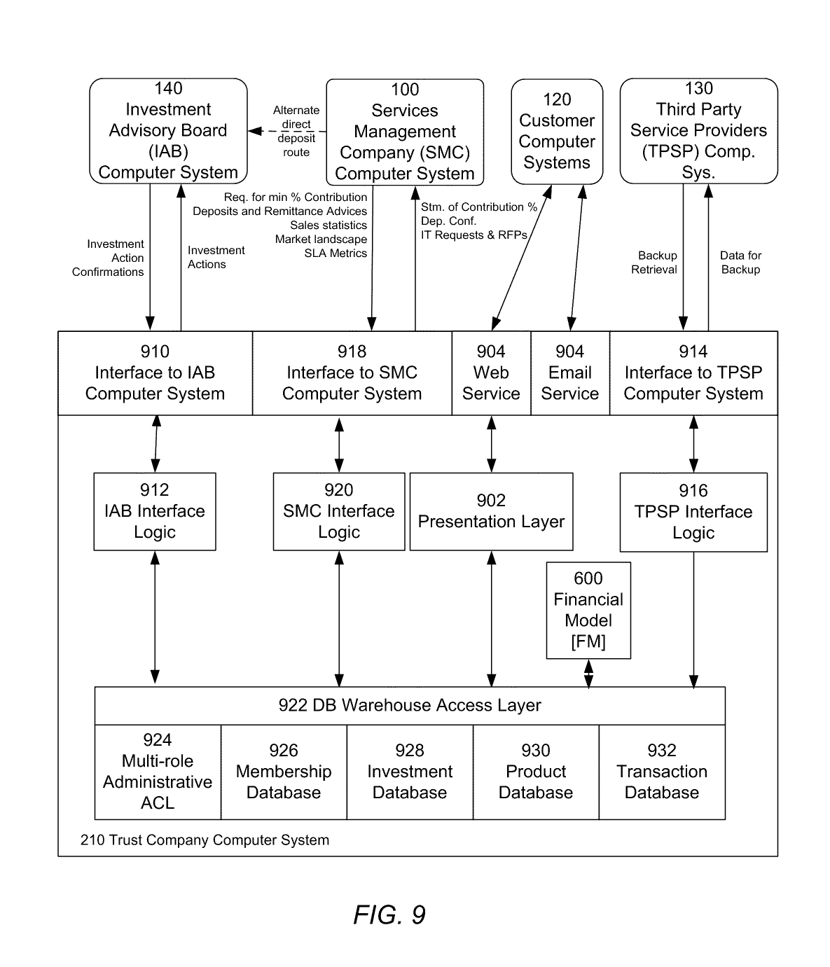

Referring now to FIG. 9 there is shown in more detail the system architecture of the trust company computer system 110. This system 110 comprises the following functional modules. Again, those of skill in the art of system architecture design will appreciate that various standard modules, such as security, backup management, failover, accounting, and so forth are not shown so as to not obscure the relevant details of the embodiment. The presentation layer 902 is responsible for handling queries from and responses to the customer computer system 120, as may be received via web interface 904 and email service interface 906. This responsibility includes accessing the underlying database 908, containing customer account information.

The investment advisory board interface 910 is configured to receive requests from and provide responses to the investment board advisory computer system 140. The requests are handled via IAB interface logic 912. The requests include requests for data regarding excess cash, costs and expenses, and any other financial information pertinent to the investment advisory board's functions. The interface logic 912 accesses the investment database 924 to obtain information responsive to these requests, and then formats the requested information in an appropriate manner.

The third party storage provider computer system interface 914 is configured to make requests from and receive responses from the third party storage provider (TPSP) computer system 130. The TPSP interface logic 916 creates and processes these requests and responses. These requests include requests for current or future storage and bandwidth costs and other information as appropriate for use in updating the financial model 600. In addition, the requests include requests for information pertaining to one or more customer vaults, such as status of vaults, individual or group utilization or access, account activity, and the like. The TSPS interface logic 916 uses the received information to make updates to the membership database 926 and the transaction database 932.

The services management computer system interface 918 is configured to provide for the communications between the services management computer system 100 and the trust company computer system 110, as managed by the services management company interface logic 920. More generally, the interface logic 920 provides for making updates to the membership database 926 when a user becomes a customer, to the administrative ACL database 924, when the customer changes user access privileges for his or her vaults, to the transaction database 932 when financial transactions are undertaken with customers and others, and to the product database 930 when making requests for available products as well as pricing information.

In one embodiment, the underlying databases 924-932 are coordinated as federated databases, and accessed through database warehouse access layer 922. This enables each of the databases to independently hosted and served, depending on performance requirements (e.g., throughput, security, and so forth).

Legal Model

Referring again to FIG. 2, a more detailed description of the legal model is now provided. The legal model may be understood to represent a method or process (series of acts) by which the various entities interact with each other to provide the digital services to the customers. These acts are now described in further detail.

As described above, the services management company 200 and trust company 210 are parties to a trust and IP transfer agreement 204. First, the agreement 204 establishes a statutory trust 212 under the Statutory Trust Act (as evidenced by an appropriately filed Certificate of Trust), performing the underlying acts that effect the establishment of the trust under in relevant jurisdiction, such as the execution and filing of documents. The trust 212 cannot be dissolved by the services management company 200, either directly, or indirectly, such as through the dissolution, liquidation, or bankruptcy of the services management company 200.

Under the IP transfer agreement 204 the services management company 200 then assigns to the trust 204 all of its rights, title and interest in certain intellectual property designated as “Core IP.” The Core IP can include software (including source code, object code, and related collateral) used to provide the various computer-implemented programs and interfaces described herein, as well as associated copyrights, trademarks, patents, trade-secrets, and information associated with such technology (which would be embodied in specific tangible media, documents, or other physical instantiations). The Core IP then constitutes the initial trust estate for the trust 212, which will be held by the trust 204 for the services management company 200. The services management company 200 may in the future contribute, or have contributed by others, additional assets (be it additional Core IP or otherwise) to the trust 204, which assets then become part of the trust estate. The trust 204 is given legal title to the trust estate (i.e., the Core IP), or alternatively, legal title is vested in the trust company 210 if so required by state law.

The services management company 200 is the beneficial owner of the trust 212, however it does not have legal title to the trust estate. Rather, the services management company 200 only has a right to receive an undivided beneficial interest in the trust estate. Further, the services management company 200 cannot terminate the trust 212 or the trust and IP transfer agreement 204 by transferring any of its beneficial interest in the trust to another party. Similarly, the customer 200 also have no title or any other interest, beneficial or otherwise, in the trust estate or any specific property therein, but only a right to receive the digital services pursuant to the customer service agreement 214 they executed with the services management company 200 and the certificate for perpetual services 208, and likewise, the customers 220 as service beneficiaries, cannot terminate the trust 212 or the trust and IP transfer agreement 204 by transferring their rights to receive the services to another party. Further, the dissolution, liquidation, or bankruptcy of the services management company 200 does not give the customers as service beneficiaries or any successor of the services management company 200 any right to partition or terminate the trust 212, nor does it affect any of the rights, obligations, or liabilities of the trust 212 and trust company 210 to the customers 220.

The services management company 200 itself is restricted in its operations in relationship to the trust 212. Specifically, the services management company 200 can only assign its rights under the trust and IP transfer agreement 204 with the written consent of the operating trustee. Further, even if the services management company 200 is to be dissolved or liquidated, it is obligated to assign all of its obligations to a successor, which in turn is under the same obligation. Thus, this aspect serves to ensure that the obligations of the services management company 200 to customers 220 and to the trust company 210 are likewise continued in perpetuity.

A beneficial consequence of the foregoing structure is that the trust 212 is ultimately obligated to provide the digital services to the customers, and this in turn requires the trust company 200, via the operating trustee, to ensure that the trust 212 is always sufficiently funded, so that is can provide the digital services, including digital storage, to the customers in perpetuity. This embodiment makes the system structurally and functionally different from existing online storage systems in which the storage company (or affiliate) makes a mere marketing promise or offers a “lifetime guarantee.” In these existing systems, if the storage company goes out of business, the guarantee is worthless, since there will be no company left to operate the storage system itself, and indeed, the storage system is typically sold off with the assets of the storage company in bankruptcy. By contrast, in the present invention, the trust 212, the trust company 200, and the trust company computer system 120 in fact exist independently of the services management company 200 and the services management computer system 100, and as such and will continue the operation of the trust company computer system 110, even if the services management company 200 goes out of business.

To further facilitate these structural aspects of the present invention, the trust 212 is constituted as a separate legal entity from the services management company 200, and an operating trustee is required to maintain the assets, liabilities and accounts of the trust 212 separate from those of the services management company 200, as well as maintaining separate accounting records and financial statements. The maintenance of such matters requires storage, updating, and maintenance of physical indicia, such as computer data files. Additionally, neither the services management company 200 nor any customer has the authority to manage, control, or participate in the business and affairs of the trust 212. Similarly, the trust 212 cannot guarantee or become obligated for the debts of the services management company 200 or any of its affiliates, hold the credit of the trust 212 out as being available to satisfy the obligations of the services management company 200, or obtain credit or incur any obligation to any third party on behalf of the services management company 200. In addition, the trust 212 must conduct all of its transactions with the services management company 200 at arm's length basis.

The trust 212 and the operating trustee of the trust company 210 are given certain powers by the trust agreement 204. These include the powers to:

a) manage the trust estate and hold it in trust for the services management company 200;

b) provide the digital services in perpetuity, both to the services management company (according to the inter-company agreement 202) and to the service beneficiaries (i.e., the customers 220), upon dissolution of the services management company 200 or otherwise;

c) issue the certificate for perpetual services 208 to the customers 220 (as service beneficiaries);

d) grant license rights to the Core IP and other intellectual property and source code to the services management company 200;

e) hold and invest any excess cash; and

f) distribute any excess cash to the services management company or the service beneficiaries or to others.

The digital services that the operating trustee is empowered to provide to customers 200 firstly include a digital asset storage service, by the customers 200 have access to perpetual storage (on the third party storage provider computer system 130) in which such customers can store and retrieve digital data in perpetuity. For purposes of reference only, this service is referred to as the core storage service.

Additional core services can also be defined to be part of the digital storage services that the trust 212 offers. For example, one core service allows the customer to designated certain digital assets from ever being deleted or modified; another core service allows the customer to enable certain third parties to submit digital assets to the customer's vault for storage; another core service allows the customer to authorize multiple recipients to access the customer's vault; and finally another core service immediately forwards the customer's stored digital assets to one or more predetermined recipients or immediately deletes such assets upon the entry of a secret code.

In one embodiment, the digital services that the operating trustee is empowered to provide to the services management company 200 include the above listed additional core digital services, and further include training the services management company 200 to market, offer, and resell (but not directly provide) such services to the customers 220. The trust 212 will warrant the performance of such services to the services management company 200 under the inter-company agreement 202. The trust 212 will then provide such services to the customers 220.

The trust 212 has an investment advisory board whose role is to provide investment advice and management recommendations to the operating trustee with respect to the investment, administration and management of the excess cash.

To further ensure the independent operation of the trust 212 and trust company 210, the trust and IP transfer agreement 204 provides that the provisions pertaining to the perpetual existence of the trust cannot be amended without the unanimous written consent of the operating trustee, the services management company 200, and all of the then current service beneficiaries (i.e. customers 220). Further, there can be no change in either the services provided under the trust 212, the operating trustee's powers, or the beneficial ownership of the trust without the written consent of the operating trustee, the services management company 200, and a super-majority (e.g., 75%) of the then current service beneficiaries (i.e. customers 220).

The second major element of the legal model is the inter-company agreement 202. As generally described above, the inter-company agreement 202 establishes the relationship and obligations between the services management company and the trust company. More specifically, the trust 212 grants to the services management company 200 a generally non-exclusive, worldwide, perpetual, irrevocable, royalty-free, fully-paid right and license to the Core IP, by which the services management company 20 can (1) resell and provide the core services to customers; (2) sublicense the services management company's right to use the core services to the customers and the customers' authorized users and partners; and (3) develop, offer for sale, sell, and provide enhanced services; and (4) support both the core services and the enhanced services. With this set of rights, the services management company 200 is positioned to fulfill its obligations, as described below.

The inter-company agreement 202 imposes certain obligations on the trust 212. First, the trust 212 is obligated to provide the core services to each customer 220 in perpetuity. While the inter-company agreement 202 is effective, the trust 212 provides the core services to each customer through the services management company 200. Significantly, should the services management company 200 fail to provide any particular customer 220 with core services for some fixed period of time (e.g., 60 days), then the customer's customer services agreement 206 will automatically terminate and the trust 212 will provide the core services directly to such customer, pursuant to the certificate for perpetual services 208. Should this event occur, then the trust 212 will inform the customer 220 that their certificate for perpetual services 208 has been triggered, and that the trust 212 will take over performance and continue to ensure the customer's access to the core services. Thus, again, whatever happens to the services management company 200, the customer 220 will continue to receive the core services it paid for in perpetuity.

Second, as mentioned with respect to the trust agreement 204, the trust 212 is obligated to issue a certificate for perpetual services 208 to each customer 220, which evidences such customer's rights to perpetually receive the core services.

Third, the trust 212 is obligated to provide the core services to the services management company 200 in a manner that allows the services management company 200 to market, offer, and resell such core services to customers and to use such services itself. This obligation thus further binds the trust 212 and the services management company 200 into a mutually beneficial arrangement. To facilitate this obligation, the trust 212 is further obligated to create and maintain the trust company computer system 110 (or some equivalent system) by which the services management company 200 and the customers 220 can access the core services and the storage provider computer systems 130.

The inter-company agreement 202 imposes complementary obligations on the services management company 200. The services management company 200 obligates itself to:

a) serve as the customer interface for all customers 220;

b) provide the core services from the trust 212 to the customer 220;

c) deliver the certificate for perpetual services 208 to the customers 220 from the trust 212 as requested by the trust 212; and

d) issue invoices to customers 220 for fees due, and receive and manage customers' payments.

In addition, the services management company 200 agrees that it will purchase perpetual digital storage services from the trust 212 only, and not from any third party or provide such functionality on its own. Again, this obligation further binds the services management company 200 and the trust 212 into a mutually supporting relationship so as ensure perpetual provisioning of the core services to the customers 220.

The inter-company agreement 202 preferably contractually defines the process by the customers order, initiate and pay for the core services, including what information is provided by the services management company 200 to the trust company 210 when purchase is made (e.g., potential customer's name, email, account number—if the potential customer is an existing customer—and other contact information, the desired quantity of storage and bandwidth). This information is passed to the trust company computer system 110. Any time the trust company computer system 110 receives a request for an updated cost of the digital services, it is obligated under the inter-company agreement 202 to determine a dollar amount to charge for such requested core services based on the financial model and the potential customer's desired allotment of storage and bandwidth, and will respond to the services management company 200 with this dollar amount. For each purchase of core services, the services management company 200 send the potential customer 220 an invoice (FIG. 3A, 322), notifies the trust company 210 with the details of the purchase (FIG. 3A, 325), and enters into a customer service agreement 214 with the customer (FIG. 3A, 330), thereby transforming the potential customer into an actual customer 220 as covered by the customer service agreement 214, certificate for perpetual services 208, trust agreement 204. The services management computer system 100 will then initiate a vault for the customer and provide the customer with the certificate for perpetual services 208 (either directly or via the services management computer system 100) (FIG. 3A, 334), which documents and guarantees customer's right to receive the core services in perpetuity. The services management company 200 will pay the core service charge to trust company 210 for core services, preferably by the end of the following calendar month (FIG. 3C, 352). Finally, as noted above, the customer is able to transfer their rights to the core services to others, by transferring their rights under the customer service agreement 214 (e.g., by contract, will or other devise). Thus, the trust 212 agrees to accept and track each such transfer from a customer 220 informing the trust company 210 that such customer has assigned their customer service agreement 214. The trust company 210 will notify the services management company 200 of each such transfer and the services management company 200 will manage the registration of such new customer.

As noted above, a customer 220 purchases a specific allotment of storage and associated bandwidth for accessing such storage. It may occur however the quantity of data a customer has stored in its vault exceeds the quantity of storage allocated to such customer, or that the amount of bandwidth a customer has used exceeds the quantity of bandwidth allocated to the customer. Should either of these events arise, the trust company 210 is to issue (electronically via the trust company computer system 110) a notice to services management company 200 identifying the customer's allocation amount, and excess used over allocation. This notice is preferably issued automatically and within one (1) hour of the occurrence of the overage. The services management company 200 will promptly confirm receipt and notify (electronically via the services management computer system 100) the customer of the excess, and provide an electronic order form (or similar means, such as a link to a webpage) that the customer 220 can use to initiate the process for ordering, initiating, and paying for the additional amount of core services necessary to cover the overage.

The inter-company agreement 202 also provides for certain warranties of performance by the trust company 210 for operation the system including the third party storage provider computer system 130 and the trust company computer system 110 as needed by the customers 220 to access their storage digital assets. Specifically, the trust 212 warrants that the core services will be accessible to each customer with an average of 95% availability as measured over rolling period (e.g., six months). Availability during any given period is calculated as

A=(y−z)/y*100%

where:

“A” is the Availability of access to the core Services during such period;

“y” is the total number of hours in such period minus, excluding the number of hours the core services are unavailable for scheduled maintenance, or non-performance of hardware, software, and other equipment that is not provided by or through the trust company 210 or under its control; and

“z” is the number of separate clock-hours in such period during which customers attempted to access the core services one or more times and found it was unavailable. For example, if customers attempted to access the core services via the services management computer system 100 or the third party storage provider computer system 130 and found it unavailable at 1:05 pm, 1:30 pm, 1:53 pm, and 2:12 pm, then z=2. However, if one customer attempted to access the core services and found them unavailable at 1:05 pm, 1:30 pm, 1:53 pm, and 2:12 pm, and that another customer attempted to access the core services and found them unavailable at 1:10 pm, 1:35 pm, 1:43 pm, and 2:08 pm, then z=4, since both customer's unsuccessful access attempts are counted in terms of clock-hours.

This warranty of availability is coupled with a corresponding right by the services management company 200 to a remedy of a sliding scale of refunds of the customer's one time fees paid to the trust company 210, from 5% refund where the availability is between 90% and 95%, a 10% refund where availability is between 75% and 90%, and a 25% refund where availability is less than 75%.

The customer service agreement 214 is the next element of the legal model. This agreement establishes the relationship between the services management company 200 and the customer 220. The customer service agreement 214 establishes that the services management company 200 will permanently provide the customer 220 with the core services, and that the term of this agreement is in perpetuity, unless terminated by the customer. The customer service agreement 214 confirms that the customer 220 becomes a service beneficiary of the trust 212 once the customer 220 makes payment of the one-time fee and uploads data to their vault at the third party storage provider computer system 130 (preferably receiving an acknowledge of this upload from the services management computer system 100, at which point the customer 220 will then receive the certificate for perpetual services 208. More specifically, the customer service agreement 214 provides that the customer's agreement to thereto constitutes an acceptance of the terms of the certificate for perpetual services 208.

The customer service agreement 214 further establishes as between the customer 220 and the services management company 200, that the customer 220 pays a single, fully paid up and generally non-refundable payment in order to obtain a specified amount of storage (called a ‘storage allotment’) on the third party storage provider computer system 130. If the customer 220 decides to increase the storage allotment at any time, they agree to pay an additional one time fee for this additional increase. The customer service agreement 214 further confirms that the one time fees is only for storage and access for their storage allotment, and any lesser usage does not increase the user's storage or bandwidth allocations. Should the customer 220 exceed their allotted storage or bandwidth for some minimum period of time (e.g., 14 days) then the services management company 200 will notify them of such overage, and will then delete any digital assets over the storage allotment on a last deposited, first deleted basis, unless the customer 220 either reduces the amount of their stored data to less than or equal to their storage allotment, or purchases an appropriate increase for the additional fee. The customer service agreement 214 also provides the customer 220 with a warranty of availability that corresponds to the warranty provided by the trust company 210 to the services management company 200 via the inter-company agreement 202. Finally, the customer service agreement 214 provides that it terminates automatically if the services management company 200 is dissolved, liquidated or otherwise ceases operations, or fails to provide the cores services to the customer for some period of time (e.g., 60 days). In this case, the customer service agreement 214 provides the trust 212 via the trust company 210 will automatically take over provision of the core services via the certificate for perpetual services 208 provided by the trust 212.

The last element of the legal model is the certificate for perpetual services 208. This certificate 208 gives the customer 220 the right to receive the core services from the trust 212 in perpetuity in response to certain triggering events. The triggering events include the services management company 200 ceasing operations, being dissolved or liquidated, or failing to provide the core services for a specified period of time. The triggering events may also include other events, such as a third party (e.g., a custodian or receiver) being appointed to take possession of the assets of the services management company 200. Once the rights under the certificate for perpetual services 208 are triggered, all of the obligations of the services management company 200 to the customer 220 are assumed by the trust 212 and the trust company 210, which then continues to provide the customer 220 access to the customer's stored digital assets on the third party storage provider computer system 130.

It should be noted that the foregoing agreements—trust and IP transfer agreement 204, inter-company agreement 202, the customer service agreement 214, the certificate for perpetual services 208, and the third party service agreements 206—are all instantiated and embodied in physical media, such as written or electronic documents, and are therefore not merely legal abstractions. In addition, these agreements impose concrete (i.e., specifically defined) and tangible, real world, physical requirements on the parties, such as the provisioning, operation, and maintenance of computer systems including both hardware and software components, the payment of fees, the recording (in accounting books, memory or other media) of payments, charges, costs, and fees for purposes including accounting, legal and regulatory compliance. A result of these agreements is a useful and highly practical application—the availability of digital services, including digital storage services, and the ability and practice of customers to store digital assets in various computer storage systems and to access such stored digital assets.

Detailed Operational Methods

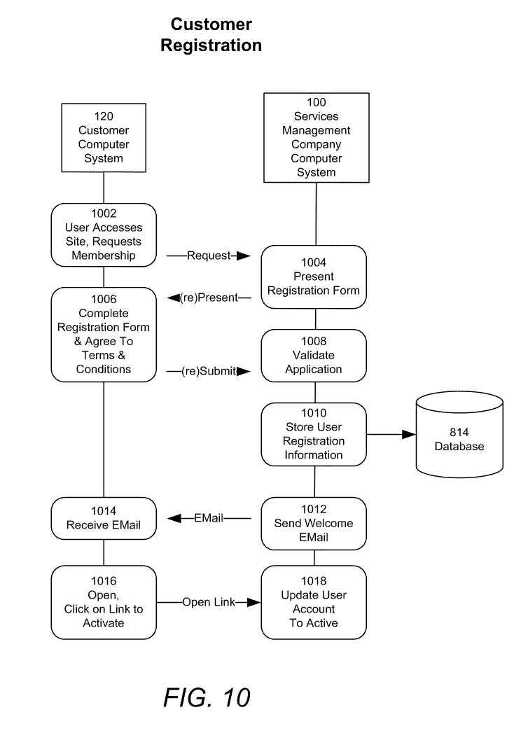

Referring now to FIGS. 10-24, there are shown flow diagrams of the specific operational methods used with in conjunction with provisioning of digital services.

FIG. 10 illustrates in more detail the registration process 304 of FIG. 3A. As noted above, the customer 220 via the customer's computer system 120 access the website of the services management company 200. The customer, via navigation through various pages, access 1002 a page on the site, and makes a request for a registration form for registering with the services management company 200. The services management company 200 provides 1004 the form to the customer's computer system 120, via an HTML page (and related code, graphics, etc., as necessary). The customer completes 1006 the registration form, providing relevant personal information, and submits that information to the services management company 200. The services management company 200 validates 1008 the application (e.g., credit check, automatic name and address verification), and then stores 1010 the customer's registration information in the database system 814. The services management company 200, via its email service 82, sends 1012 a “welcome” email to the customer computer system 120; this email contains an activation link that links back to the services management company 200 to activate the customer's account. The customer receives 1014 the email, and clicks 1016 on the activation link, which returns the customer's computer system 120 to the services management company 200. This activates 1018 the customer's account.

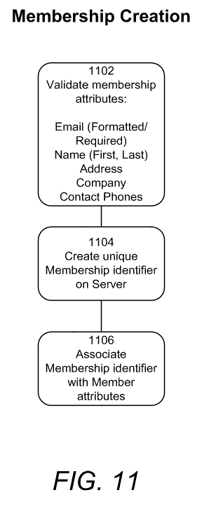

FIG. 11 illustrates in more detail the process of creating 326 a membership in the trust company computer system 110. Via the trust interface 812, the services management computer system 100 accesses the trust company computer system 110, and passes in a data file containing membership information for the customer 220. The trust company computer system 110 validates 1102 that this membership information is complete, as including a full name, email address, physical address, company name, and phone numbers. The trust company computer system 110 then creates 1104 a membership identifier for the customer in its database 814 and stores this information in a new a member record for the customer. The trust company computer system 110 further associates 1106 the membership identifier with the various membership attributes for subsequent retrieval and processing (e.g., checking of member attributes upon login of a member identifier).

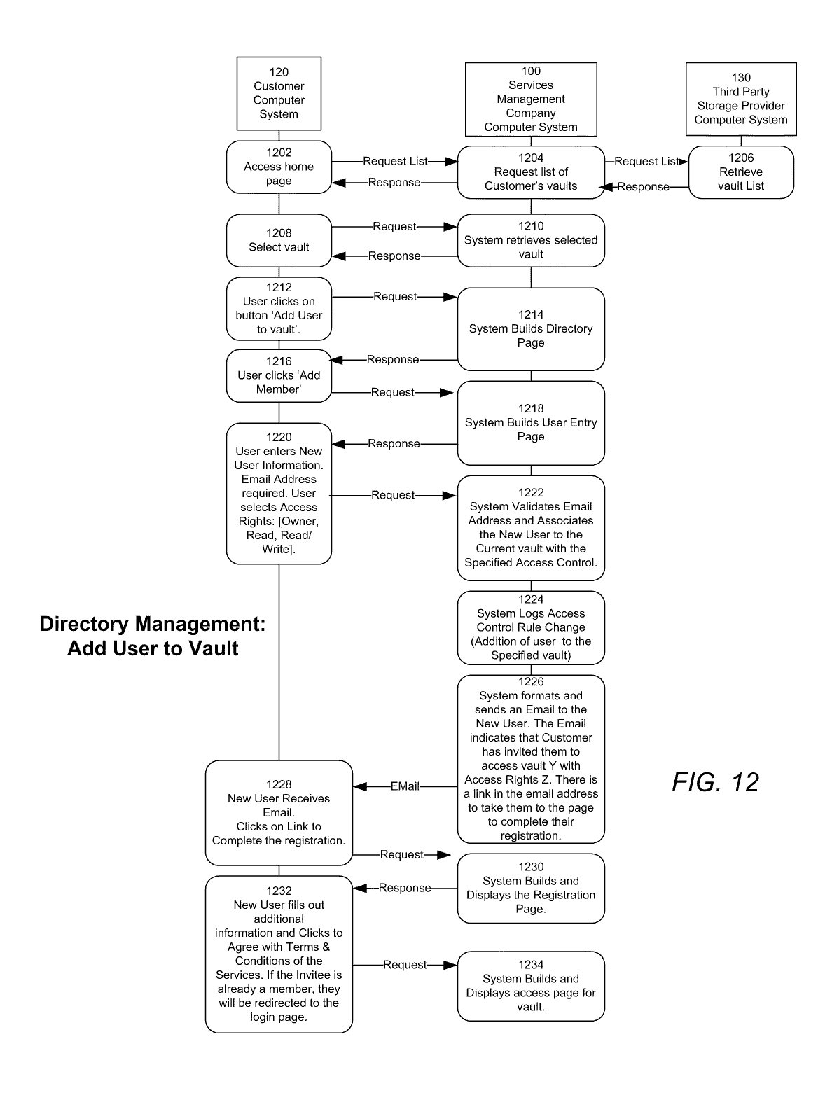

FIG. 12 illustrates in more detail the process 342 of the customer 220 defining the directory access rights for other users of the customer's vault, in particular for adding a new user to the customer's digital vault. This process can occur at the time the customer initially signs up for the service, or any time the customer has logged into the services management computer system 100. After logging in, the customer is presented 1200 with a home page. As part of this process, the services management computer system 100 requests 1202 the third party storage computer system 130 to provide a list of the customer's vaults by passing in the customer identifier. The third party storage computer system 130 does a lookup 1204 and provides to the services management computer system 100, which constructs the home page with this list. The customer selects 1208 the vault for which they wish to modify other user's access privileges (a customer can establish more than one vault, and thus this selection allows for individualized control of the access control list for each of the customer's vaults). The services management computer system 100 retrieves 1210 the selected vault and display identifying information thereof on a web page; the page include buttons for features for managing users of the vault. The customer 220 selects 12012 an option to add a user to the vault. The services management computer system 100 then builds 1214 a directory of the current users. The customer 220 then selects 1216 an option to add a member to the system. The system then creates 1218 a user data entry page for receiving identification information for the new user; this user data entry page is sent back to the customer computer system 120. The customer 220 then enters 1220 the identification information for the new user, including email address, name, and so forth. The customer 220 also identifies the new users access rights, including whether the new user is consider an owner of the vault (with full read/write/delete), read access, or read/write access. Once the customer submits this information, the customer need not take any further action.

The system receives the new user information, and validates 1222 the new user's email address as a well formed address, and associates the new user with the customer 220's vault, along with the designated access privileges, and updates 1224 and access control log with information identifying the new user a member allowed to access the vault. The system (via email service 802) formats and sends 1226 an email to the user new, indicating the customer (preferably identified by name) has invited them to access a particular value with specific level of access rights. The email includes a link to a registration page for the user to complete the registration process.

The new user receives this email, and activates 1228 the registration link, which leads to a registration page provided 1230 by system. The user enters a user name and password, and confirms 1232 acceptance of any stated terms and conditions. The system then displays 1234 the customer's vault that the user has been authorized to access. The user is already a member, then upon submission, they are redirected to a login page where they enter their prior login information.

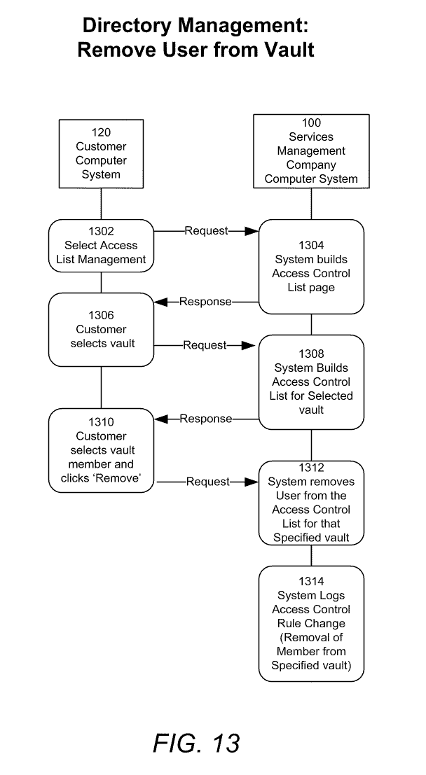

FIG. 13 illustrates in detail a further directory management process for the customer to remove an existing user from accessing a vault. From a menu page, the customer selects 132 a link for access control management. The services management computer system 100 builds and provides the access control management page to the customer's computer system 120. The customer selects 136 the particular vault for which they want to update the access privileges. The services management computer system 100 accesses the access control list page and provides 138 that to the customer computer system 120. This page lists the user(s) who have access to the vault and their specific privileges. The customer selects 1310 the particular user to remove via a remove link. The services management computer system 100 removes 1312 the selected user from the access control list for the vault, updating the appropriate tables in the various database tables. The services management computer system 100 then logs 1314 the access control change for audit purposes.

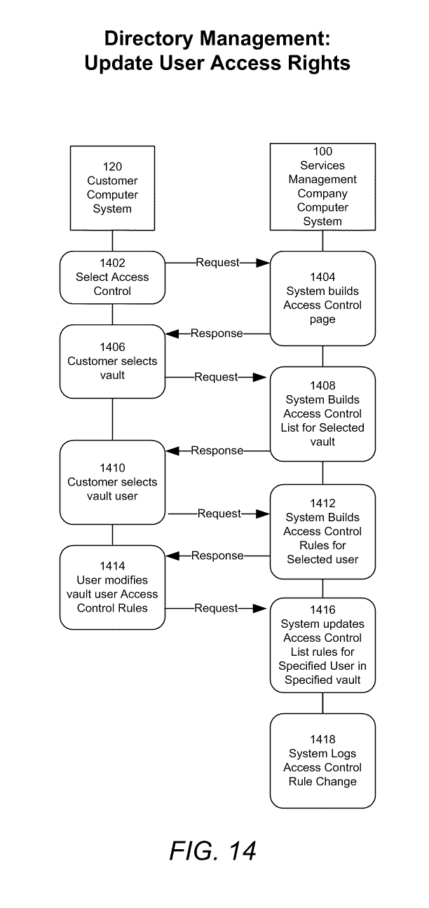

FIG. 14 illustrates in detail a further directory management process for the customer to update the access privileges of another user of the customer's vault. From a menu page, the customer selects 142 a link for access control management. The services management computer system 100 builds and provides the access control management page to the customer's computer system 120. The customer selects 146 the particular vault for which they want to update the access privileges. The services management computer system 100 accesses the access control list page and provides 148 that to the customer computer system 120. This page lists the user(s) who have access to the vault and their specific privileges. The customer selects 1410 the particular user that they wish to update the access privileges. The services management computer system 100 builds 1412 a page with the access control privileges (rules) for the selected user. The customer then modifies 1414 the access control rules for this user, and submits the modified rules to the system. The services management computer system 100 updates 1416 the access control list rules for the user, updating the appropriate tables in the various database tables. The services management computer system 100 then logs 1418 the access control change for audit purposes.

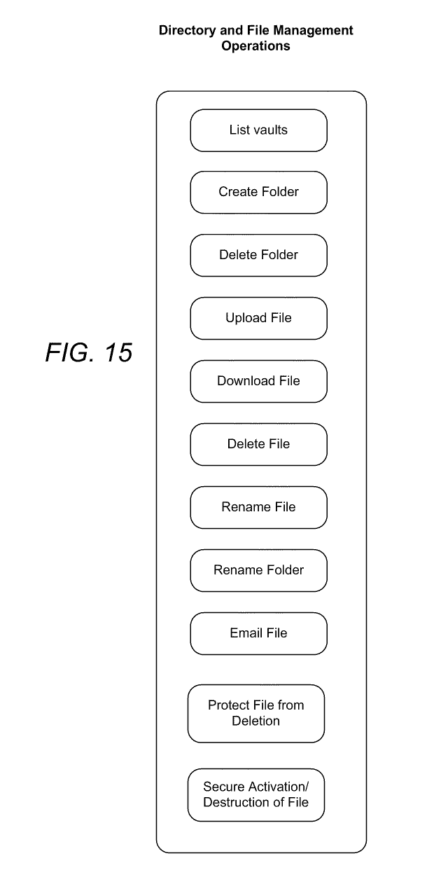

FIG. 15 illustrates the set of directory management operations available for managing the folders and files in a customer's vault. The figure is self explanatory.

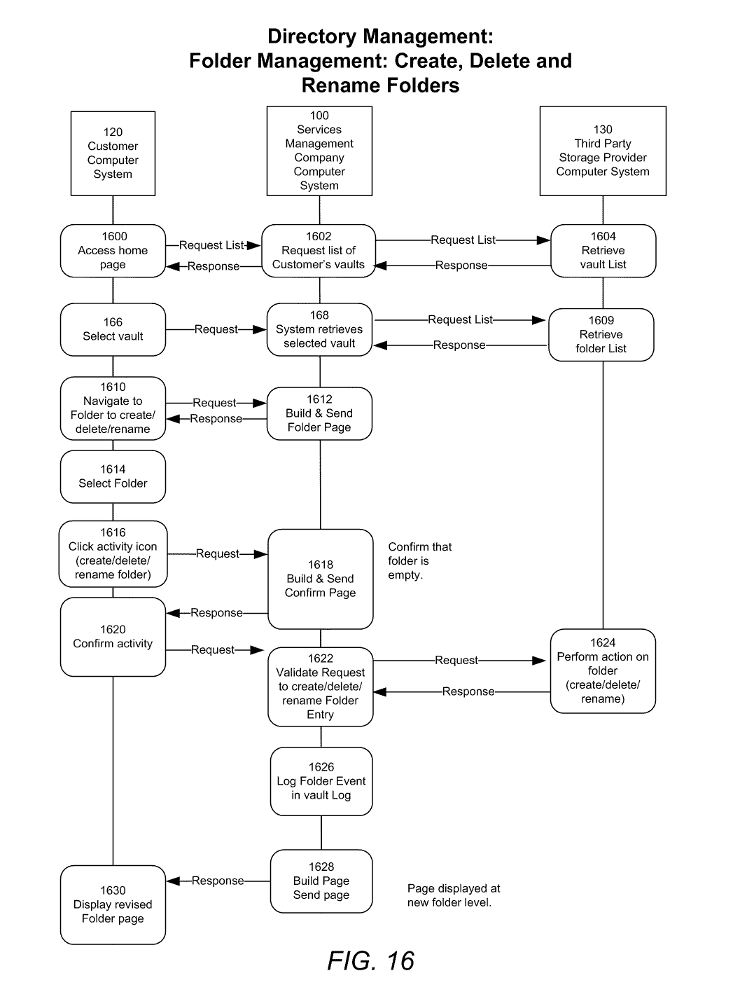

FIG. 16 illustrates in detail the directory management operation of creating, deleting, and renaming folders in a customer's vault. This process can occur at the time the customer initially signs up for the service, or any time the customer has logged into the services management computer system 100. After logging in, the customer is presented 1600 with a home page. As part of this process, the services management computer system 100 requests 1602 the third party storage computer system 130 to provide a list of the customer's vaults by passing in the customer identifier. The third party storage computer system 130 does a lookup 1604 and provides the list to the services management company 200, which constructs the home page with the list of vault(s). The vaults will include those the customer owns as well as those to which the customer has been granted access by others. The customer selects 1606 the vault for which they wish to modify the folder directory. The services management computer system 100 requests 1608 a list of the folders for the selected vault from the third party storage computer system 130, and returns 1609 a page with the folder information. The customer navigates 1610 to the particular folder that they want to rename or delete, or within which they want to create a new folder, traversing the directory structure as provided 1612 by the services management computer system 100. The customer then selects 1614 the folder of interest, and clicks 1616 for the activity (create, rename, delete) that they wish to undertake. If the customer is creating or renaming a folder, an input form is displayed for this activity. The services management computer system 100 builds and sends 1618 a confirmation page; if the folder is to be deleted, the services management computer system 100 further confirms that the folder is empty or otherwise warns that the folder is not empty. The customer then confirms 1620 the selected activity. The services management computer system 100 validates 1622 the requested activity by making sure that the folder name is unique at the current directory level and that the folder name conforms to the required format (e.g., no spaces), and then makes a request to the third party storage provider computer system 130 to perform 1624 the activity on the customer's folder. Upon completion, the services management computer system 100 logs 1626 the folder activity to the vault log for auditing. The services management computer system 100 then builds and sends 1628 a revised directory page to the customer's computer.

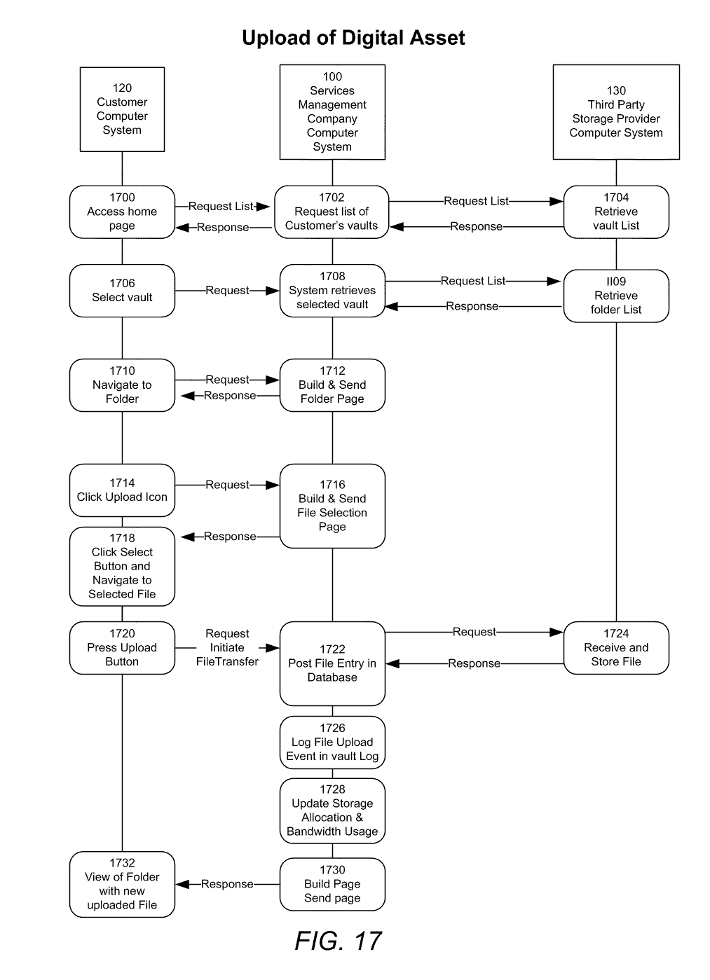

FIG. 17 illustrates in more detail the process of uploading a digital asset to the customer's vault. This process can occur at the time the customer initially signs up for the service, or any time the customer has logged into the services management computer system 100. After logging in, the customer is presented 1700 with a home page. As part of this process, the services management computer system 100 requests 1702 the third party storage computer system 130 to provide a list of the customer's vaults by passing in the customer identifier. The third party storage computer system 130 does a lookup 1704 and provides the list to the services management computer system 100, which constructs the home page with the list of vault(s). The vaults will include those the customer owns as well as those to which the customer has been granted access by others. The customer selects 1706 the vault into which they wish to upload a digital asset. The services management computer system 100 requests 1708 a list of the folders for the selected vault from the third party storage computer system 130, and returns 1709 a page with the folder information. The customer navigates 1710 to the particular folder into which they want to upload a digital asset, traversing the directory structure as provided 1712 by the services management computer system 100. The customer then selects an upload icon (or link). The services management computer system 100 then builds and sends 1716 a page allowing for the customer to select a file from the desktop or network for uploading. The customer clicks a select (or browse) icon and then navigates 1718 to the file to be uploaded. The customer then selects 1720 an upload button to initiate the file transfer process for uploading the file. The file transfer can be either direct to the third party storage computer system 130 or indirect through the services management computer system 100. The services management computer system 100 then posts 1722 an entry its database for the upload and transfers the file to the third party storage computer system 130, which receives and stores 1724 the file. The file may be stored in a compressed and encrypted form, as necessary for both security and efficiency. The third party storage computer system 130 provides a indication that the file was successfully stored, and the services management computer system 100 logs 1726 the storage event in the vault log for the customer. The services management computer system 100 updates 1728 it records to reflect reduced storage allocation remaining for the customer and the bandwidth usage from the upload, based on the size of the downloaded file. The services management computer system 100 then builds and sends 1730 a page to the customer computer system indicating that the file has been successfully uploaded, and showing the file as listed in the folder selected by the customer.

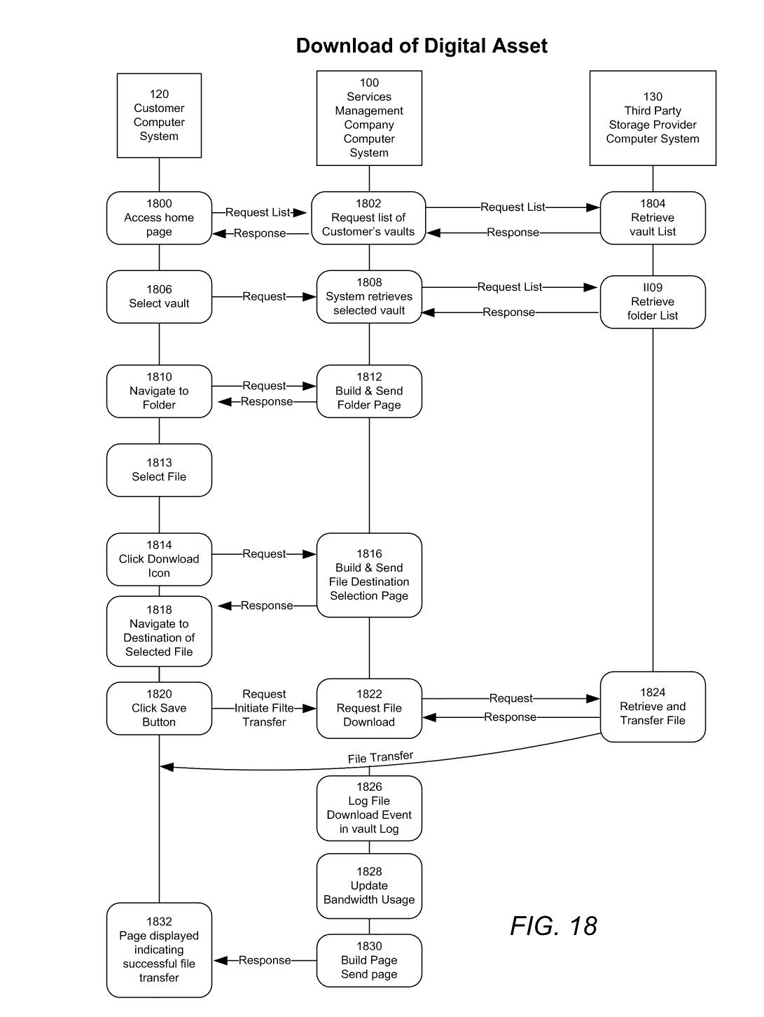

FIG. 18 illustrates in more detail the process of downloading a digital asset from the customer's vault. After logging in, the customer is presented 1800 with a home page. As part of this process, the services management computer system 100 requests 1802 the third party storage computer system 130 to provide a list of the customer's vaults by passing in the customer identifier. The third party storage computer system 130 does a lookup 1804 and provides this list to the services management computer system 100, which constructs the home page with the list of vault(s). The vaults will include those the customer owns as well as those to which the customer has been granted access by others. The customer selects 1806 the vault from which they wish to download a file. The services management computer system 100 requests 1808 a list of the folders for the selected vault from the third party storage computer system 130, and returns 1809 a page with the folder information. The customer navigates 1810 to the particular folder into which they want to upload a digital asset, traversing the directory structure as provided 1812 by the services management computer system 100. The customer then selects 1813 a file to be downloaded, and clicks 1814 a download icon.

The services management computer system 100 then builds and sends 1816 a page allowing for the customer to select a destination device and directory (e.g., their desktop or “My Documents” folder) for saving the selected file. The customer then navigates 1818 to the destination device and folder, and inputs as well a name for the file to be saved under. The customer then selects 1820 a save button to initiate the file transfer process for downloading the file. The services management computer system 100 then requests 1822 a file transfer from to the third party storage computer system 130, providing the IP address of the customer computer system as needed for the transfer. The third party computer system 130 retrieves and transfers 1824 the file. The file transfer here can be accomplished with FTP or a similar protocol; preferably the file transfer method includes multiple secure key exchanges, including secret session key, and an encryption key for encryption of the digital assets. The third party storage computer system 130 provides a indication that the file was successfully downloaded, and the services management computer system 100 logs 1826 the download event in the vault log for the customer. The services management computer system 100 updates 1828 its records to reflect the bandwidth usage form the download, based on the size of the downloaded file. The services management computer system 100 then builds and sends 1830 a page to the customer computer system indicating that the file has been successfully downloaded. The customer can then access the file through their file browser.

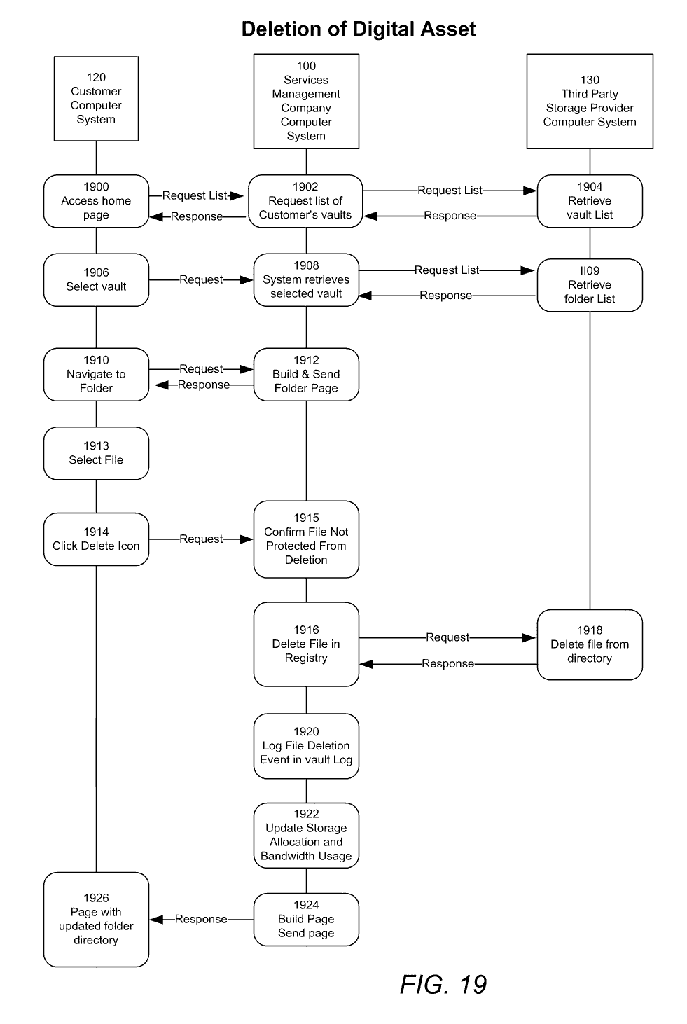

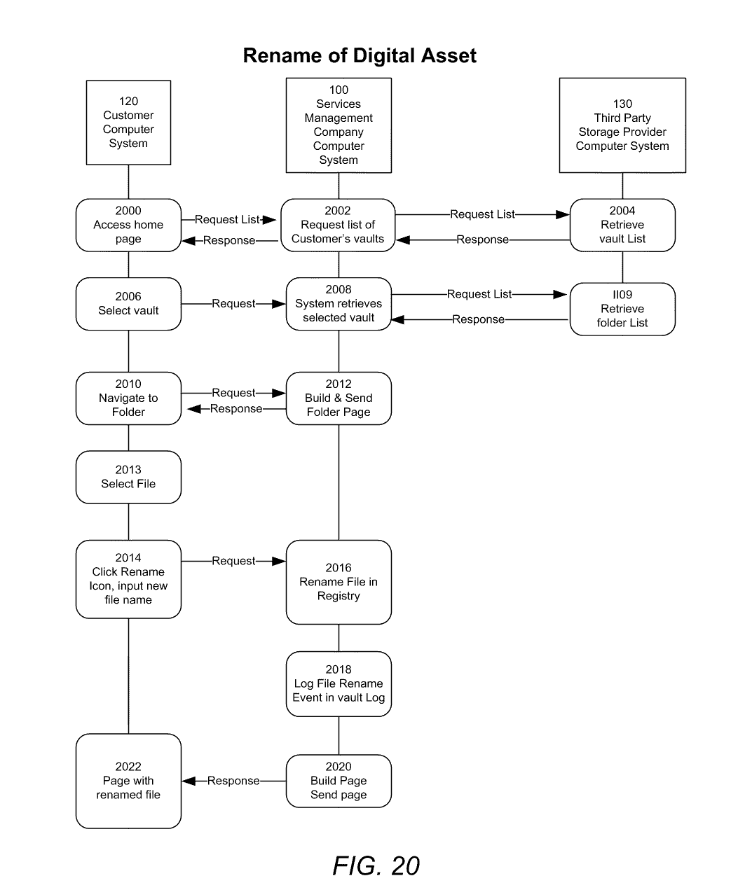

FIG. 19 illustrates in more detail the process of deleting a digital asset from the customer's vault. After logging in, the customer is presented 1900 with a home page. As part of this process, the services management computer system 100 requests 1902 the third party storage computer system 130 to provide a list of the customer's vaults by passing in the customer identifier. The third party storage computer system 130 does a lookup 1904 and provides this list to the services management computer system 100, which constructs the home page with the list of vault(s). The vaults will include those the customer owns as well as those to which the customer has been granted access by others. The customer selects 1906 the vault from which they wish to delete a digital asset. The services management computer system 100 requests 1908 a list of the folders for the selected vault from the third party storage computer system 130, and returns 1909 a page with the folder information. The customer navigates 1910 to the particular folder from which they wish to delete a digital asset, traversing the directory structure as provided 1912 by the services management computer system 100. The customer then selects 1913 a file to be deleted, and clicks 1914 a delete icon.

The services management computer system 100 confirms 1915 that the selected file is protected from deletion. This feature beneficially ensures that certain digital assets identified by the customer are protected and cannot be either accidentally or intentionally deleted. If the file is protected, then the services management computer system 100 provides a message that the file cannot be deleted. If the file is not protected, then the services management computer system 100 then deletes 1916 the file from the database registry for the customer's vault, and requests the third party storage computer system 130 to delete the file as well. The third party computer system 130 deletes 1918 the file from the user's vault (or otherwise releases the storage allocation for other usage). The third party storage computer system 130 provides a indication that the file was successfully deleted. The services management computer system 100 logs 1920 the deletion event in the vault log for the customer, and updates 1922 its records to reflect the increased capacity remaining in the customer's storage allocation, as well as updating the bandwidth usage measure for the customer. The services management computer system 100 then builds and sends 1924 a page to the customer computer system indicating that the file has been successfully deleted, and showing the folder without the file.

FIG. 20 illustrates in more detail the process of renaming a digital asset in the customer's vault. After logging in, the customer is presented 2000 with a home page. As part of this process, the services management computer system 100 requests 2002 the third party storage computer system 130 to provide a list of the customer's vaults by passing in the customer identifier. The third party storage computer system 130 does a lookup 2004 and provides this list to the services management computer system 100, which constructs the home page with the list of vault(s). The vaults will include those the customer owns as well as those to which the customer has been granted access by others. The customer selects 2006 the vault from rename a file. The services management computer system 100 requests 2008 a list of the folders for the selected vault from the third party storage computer system 130, and returns 2009 a page with the folder information. The customer navigates 2010 to the particular folder from which they wish to rename a digital asset, traversing the directory structure as provided 2012 by the services management computer system 100. The customer then selects 2013 a file to be renamed, and clicks 2014 a rename icon, and inputs a new file name.

The services management computer system 100 then updates 2016 the name of file in the database registry for the customer's vault. The services management computer system 100 logs 2018 the rename event in the vault log for the customer. The services management computer system 100 then builds and sends 2022 a page to the customer computer system indicating that the file has been successfully renamed, and showing the folder with the renamed file.

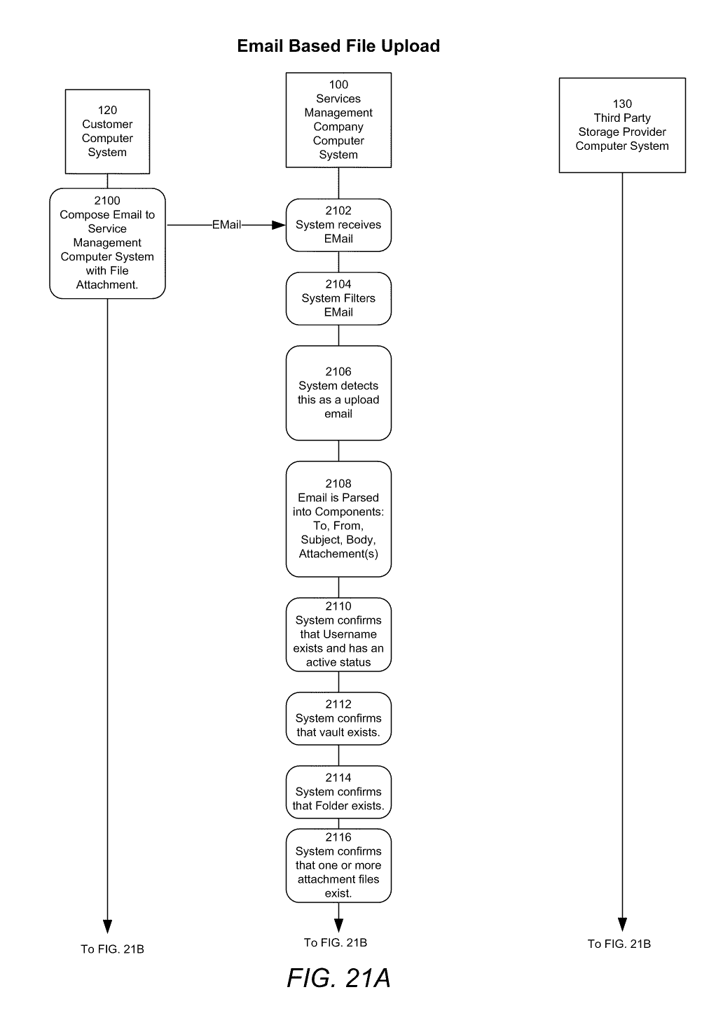

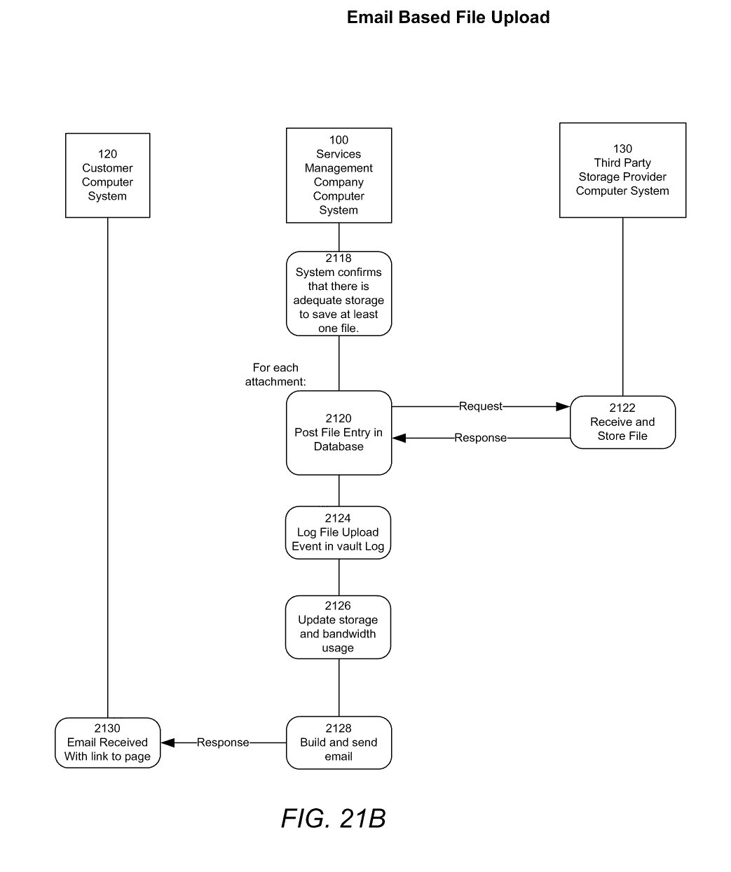

FIGS. 21A-21B illustrate in detail the process of uploading a digital asset by email. This process allows a customer (or any user of the customer's vault) to upload a digital asset to the customer's vault without having to directly access the services management computer system 100 website. This is beneficial as this makes it particularly easy for a user to upload a file within the course of other activities, using any email client. In addition, because there may be instances when a user has access to an email client but not a robust web browser (e.g., on certain thin client devices, or personal digital assistants), the user is able to use the storage service in these circumstances.

Accordingly, the customer/user composes 2100 an email on any email client application. The email takes a predetermined recipient address format as follows:

To: [UUU/AAA/FFF@iforem.com]

From: [Any]

Subject: [Any]

Attachment: [Filename1(,Filename2 . . . )]

### Where:

UUU=Username

AAA=vault

FFF=Folder

Filename1=File(s) sending to the vault.

The recipient address format here identifies the user, the vault, and then the folder within the vault into which the upload the file. The attachments are the files to be uploaded. The destination address format may vary to include other parameters as well, or to change the order, as desired by the system administrator. This email is then transmitted by the client application to the services management computer system 100.

The services management computer system 100 receives 2102 this email and filters 2104 via spam filter 84. The services management computer system 100 then identifies 2106 the email as an upload email based on the addressing format of the recipient. The email is then parsed 2108 into its components, including the To, From, Subject, Body, and Attachments. The To component is further parsed into the Username, vault name and folder name elements. The services management computer system 100 then confirms 2110 that the username exists as an active user of the system. The services management computer system 100 also confirms 2112 that the vault exists in the system and that the user has access to this vault. The services management computer system 100 confirms 2114 that the folder exists within the vault. The services management computer system 100 then confirms 2116 that there are one or more file attachments, and determines the file size of each attachment, as well as the total size.

The services management computer system 100 then determines 2118 that there is sufficient storage left in the vault to store at one of the files. For each file attachment, the services management computer system 100 posts 2120 an entry into the database 814, and transfers the file to the third party computer system 130, which receives and stores 2122 the file. This is repeated for each file than can be stored. If there is less than enough storage for all of the files the services management computer system 100 can select which of the files to store, for example, maximizing the either the number of files stored within the remaining storage allocation, or maximizing the amount of storage used, or simply storing the files from smallest to largest, or largest to smallest, until no further room is available.

The filed may be stored in a compressed and encrypted form, as necessary for both security and efficiency. The third party storage computer system 130 provides an indication that the file was successfully stored, and the services management computer system 100 logs 2124 the storage event in the vault log for the customer. The services management computer system 100 updates 2126 the folder and file table 818 to reflect reduced storage allocation remaining for the customer and the bandwidth usage from the upload, based on the size of the downloaded file. The services management computer system 100 then builds and sends 2128 an email to the user to the customer computer system indicating that the file has been successfully uploaded, and including a link to a page that shows 2130 the file as listed in the folder selected by the user.

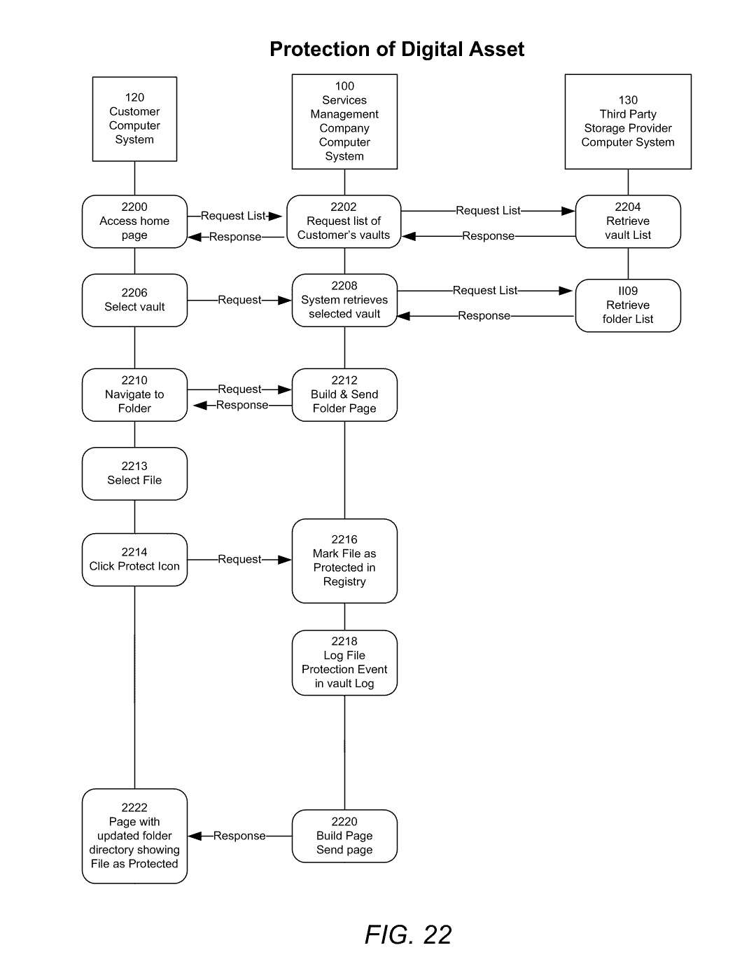

As noted above, one of the additional core services allows the customer to designate certain digital assets from ever being deleted or modified. FIG. 22 illustrates in detail the process of protecting a digital asset from deletion/modification in the customer's vault. After logging in, the customer is presented 2200 with a home page. As part of this process, the services management computer system 100 requests 2202 the third party storage computer system 130 to provide a list of the customer's vaults by passing in the customer identifier. The third party storage computer system 130 does a lookup 2204 and provides this list to the services management computer system 100, which constructs the home page with the list of vault(s). The vaults will include those the customer owns as well as those to which the customer has been granted access by others. The customer selects 2206 the vault in which they wish to protect a digital asset. The services management computer system 100 requests 2208 a list of the folders for the selected vault from the third party storage computer system 130, and returns 2209 a page with the folder information. The customer navigates 2210 to the particular folder in which they wish to protect a digital asset, traversing the directory structure as provided 2212 by the services management computer system 100. The customer then selects 2213 a file to be protected, and clicks 2214 a “Protect” icon.

The services management computer system 100 then marks as protected 2216 the file in the database registry for the customer's vault. The services management computer system 100 logs 2218 the file protection event in the vault log for the customer. The services management computer system 100 then builds and sends 2220 a page to the customer computer system indicating that the file has been successfully protected, and showing the folder with the file having an indication (e.g., icon, coloration) indicating the protected status. In any subsequent operation on the file, such as attempt to delete or modify the file, the services management computer system 100 will block such operation.

Another additional core service is the ability to immediately forward all or some the customer's stored digital assets to one or more predetermined recipients and/or immediately delete such assets upon the entry of a secret code. These operations are called secure activation and secure destruction, respectively. These two operations operate as fail-safes for a customer's digital assets. For example, a customer may store highly valuable information in digital form, such as a will and associated secret bank accounts numbers. Assume that the customer set these assets for secure activation, along with a secret code, and the email address of his attorney. Further, he gives this secret code to his spouse. At some future time, the customer dies, and the spouse sends the secret code to the services management computer system 100. The services management computer system 100 validate the secret code and transmits the selected digital assets to the attorney. This is just one of the many potential usages of secure activation.

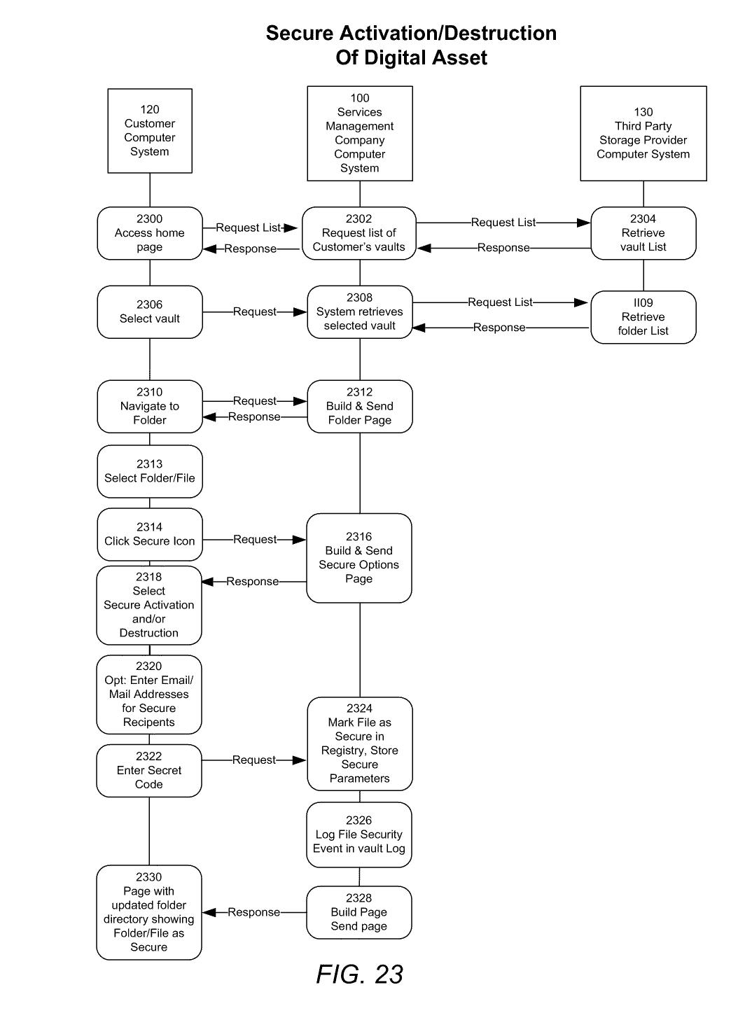

FIG. 23 illustrates in detail the process of configuring a digital asset for secure activation or secure destruction. After logging in, the customer is presented 2300 with a home page. As part of this process, the services management computer system 100 requests 2302 the third party storage computer system 130 to provide a list of the customer's vaults by passing in the customer identifier. The third party storage computer system 130 does a lookup 2304 and provides this list to the services management computer system 100, which constructs the home page with the list of vault(s). The vaults will include those the customer owns as well as those to which the customer has been granted access by others. The customer selects 2306 the vault in which they wish to establish a secure activation or destruction of a digital asset. The services management computer system 100 requests 2308 a list of the folders for the selected vault from the third party storage computer system 130, and returns 2309 a page with the folder information. The customer navigates 2310 to the particular folder they wish secure a digital asset, traversing the directory structure as provided 2312 by the services management computer system 100. The customer then can also selects 2313 a file or folder to be set as secure, and clicks 2314 a “Secure” icon.

The services management computer system 100 then builds and sends 2316 a page with the options for establishing secure activation or secure destruction. The customer selects one or both of secure activation and/or secure destruction. A customer may select both of these, for example, in order to have a digital asset both transmitted to another party, and then removed (destroyed) in the vault. If the customer selects secure activation, the customer further provides 0020 the email and/or physical address of one or more recipients for receiving the digital asset. If a physical address is provided, then a physical media (e.g., CD-ROM, DVD-ROM, or print out) of the digital asset will be sent to the recipient. The customer then provides a secret code which will be used to initiate the secure activity. The secret code can be a password or phrase, or the like. A unique secret code is preferably used for each secure operation established by the customer. The customer may also include an authentication token, such as a digital certificate or other secure factor. (Alternatively, the secret code can be provided by the services management computer system 100, for example based on a hash function of the digital assets to be secured, the customer's identification information and the like.) This information is then submitted to the services management computer system 100.

The services management computer system 100 marks as secure 0024 the file in the database registry, and stores the security parameters (e.g., activation or destruction, addresses, secret codes). The services management computer system 100 logs 2326 the file security event in the vault log for the customer. The services management computer system 100 then builds and sends 2328 a page to the customer computer system indicating that the file has been successfully secured, and showing the folder with the file having an indication (e.g., icon, coloration) indicating the security status.

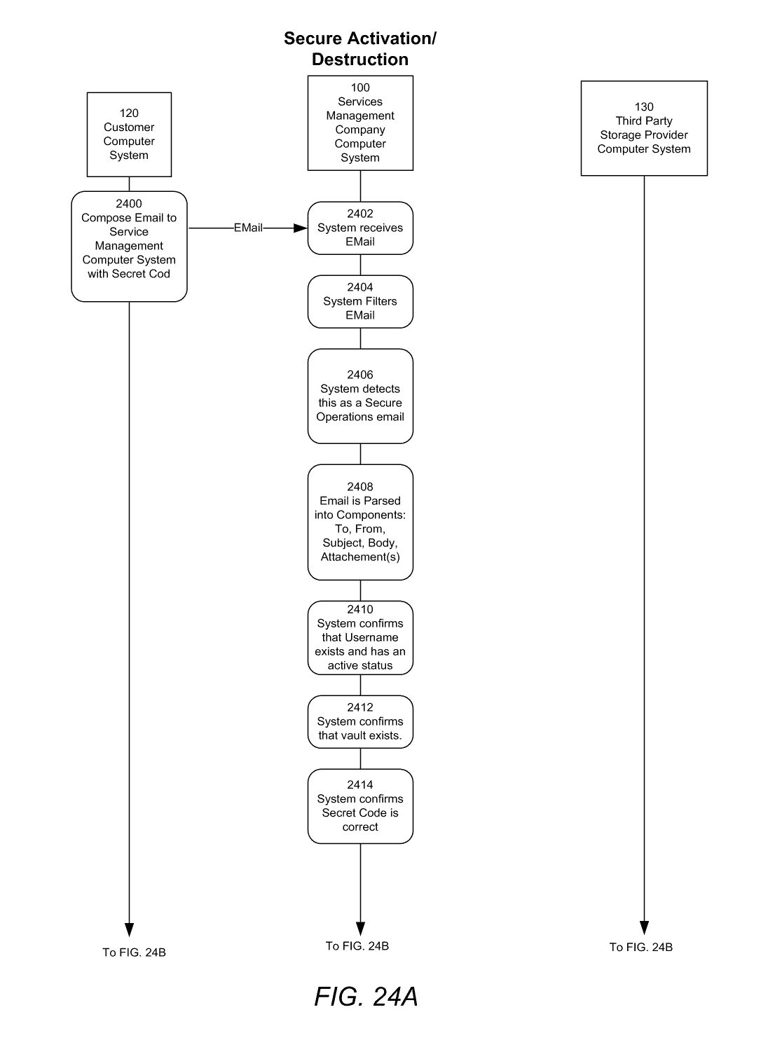

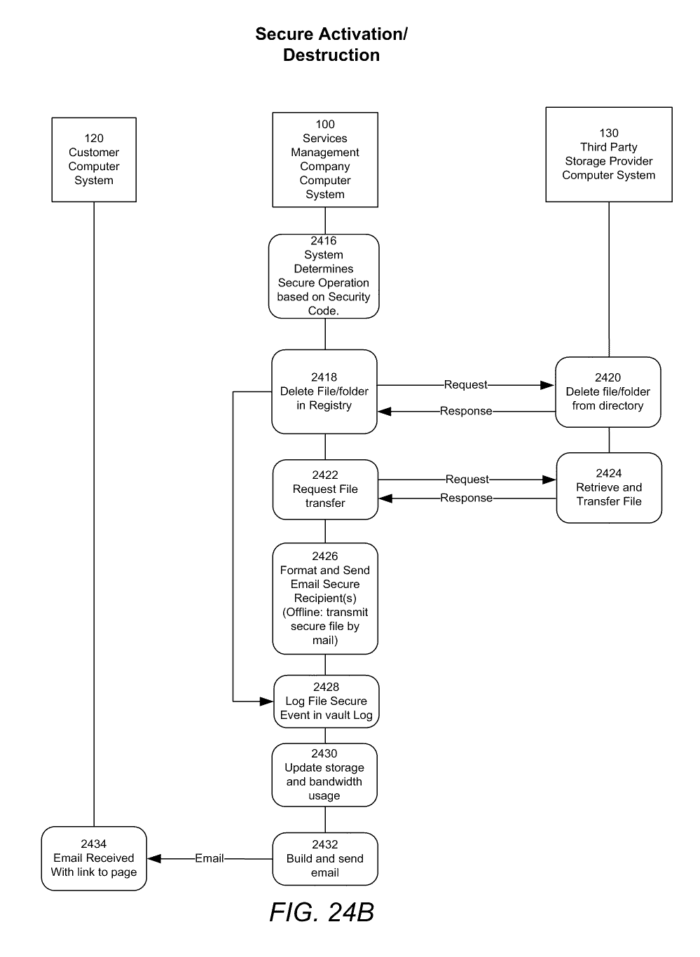

FIG. 24 illustrates in detail the operations for effecting a secure activation or destruction of a digital asset. These operations can be initiated by a customer or authorized user transmitting a message, such as an email, telephone message, or the like to the services management computer system 100, providing the secret code and identification of the customer for whom the secure activity is to be undertaken.

For the purposes of explanation, it is assumed here that the message is an email, though the following steps can be readily configured to other message types. Accordingly, the customer or other user composes 2400 an email on any email client application. The email takes a predetermined recipient address format as follows:

To: [UUU/AAA/CCC@iforem.com]

From: [Any]

Subject: [Any]

Attachment: [OPT: Authentication Token]

### Where:

UUU=Customer

AAA=vault

CCC=Secret Code

Authentication Token: an optional security factor, such as a digital signature.

The recipient address format here identifies the customer who owns the vault, the vault, and the security code. An optional authentication token maybe attached as well. The destination address format may vary to include other parameters as well, or to change the order, as desired by the system administrator. This email is then transmitted by any client application to the services management computer system 100.

The services management computer system 100 receives 2402 this email and filters it 2404 via spam filter 84. The services management computer system 100 then identifies 2406 the email as a secure operations email based on the addressing format of the recipient. The email is then parsed 2408 into its components, including the To, From, Subject, Body, and Attachments. The To component is further parsed into the Username, vault name and secret code elements. The services management computer system 100 then confirms 2410 that the username exists as a customer of the system. The services management computer system 100 also confirms 2412 that the vault exists in the system. The services management computer system 100 confirms 2414 that the secret code matches the secret code that the customer established for the folder/files within the vault, thereby validating the secret code. The services management computer system 100 also matches the authentication token to a corresponding authentication token if the customer established one when setting up the secure operation.

The services management computer system 100 then determines 2416 the security operation that is associated with the secret code (since each secret code of a customer is uniquely associated with a particular security operation), that is whether the operation is a secure activation, secure destruction or both, and retrieves the associated parameters for each. For both secure activation and secure destruction determines the folder/files to be acted upon. For secure activation, the services management computer system 100 further determines the email or physical addresses of the intended recipients.

Where the secure operation is file/folder destruction, the services management computer system 100 deletes 2418 the appropriate file/folder from the database registry, and sends a request to third party storage provider computer system 130 to also delete 2420 these file/folders(s). If there is secure activation as well (or only), the services management computer system 100 requests 2422 a file transfer of the appropriate files from the third party storage provider computer system 130, which processes this request and transfers 2424 the files to the services management computer system 100. The services management computer system 100 then formats and sends 2426 the file(s) via email to the specified recipients, and optionally/alternatively prepares the files for an offline transmission of the file(s), for example by queuing the file to be saved to a CD-ROM or other physical media and then mailed to the recipients at the provided physical address.

In both cases, the services management computer system 100 logs 2428 the secure event in the vault log, and updates 2430 the storage and bandwidth usage (e.g., increasing available storage where a file is destroyed). The services management computer system 100 then builds and sends 2432 an email to the customer indicating the secure operations that have been undertaken. This email is received by the customer's email client and includes a link to a page on the services management computer system 100 website showing the updated folder and vault status.

The present invention has further embodiments and applications in addition to those described above. One such embodiment is the provisioning of a software escrow service. In this embodiment, the customer is a software developer. The software developer can create a vault into which the developer stores digital assets such as software files (e.g., code, data, development documents, etc.) or other tangible forms of intellectual property. The developer can identify as other users with access rights to the vault those individuals or entities for whom the software is being held in escrow, such as a business client of the developer, or any other party. The developer can define the conditions under which these parties have access to the stored digital assets, using the secure activation functionality described above. The ease of setup of the digital vault, as described above, enables the software developer to have an entirely automated process for escrowing software pursuant to development or sales or other types of agreements. The developer can then provide the other party with the access information, including the vault information, secret code and authentication token, so that the other party can access the escrowed software under the defined conditions. In one embodiment of the software escrow service, additional maintenance fees are charged to the developer.

Alternatively, the system allows the software developer to load software files to a vault, without specifying other users (e.g., customers of the developer) having access rights. This approach allows the developer to later provide customers or others with access on demand to the escrowed content, by providing such party with the access information to the vault.

To further facilitate a software escrow service, the services management computer system 100 can provide, via the website, a contract formation and negotiation interface by which the parties to the software escrow agreement can defines the terms of release of the stored digital assets, for example release of the assets due to bankruptcy, failure of performance, or any other condition.

The services management computer system 100 further provides an dispute management interface by which the parties can initiate a dispute related to the escrowed digital assets. When a dispute is initiated, the services management computer system 100 monitors and controls the terms and timing of the dispute between the parties, and enables communications betweens the parties related to the dispute. During the dispute, the services management computer system 100 freezes escrowed assets by prohibiting any access to the escrowed assets in the vault. When the dispute has been resolved in favor of the beneficiary, e.g., through mediation, the services management computer system 100 enables access to the escrowed assets by the beneficiary.

Thus the present invention provides a fully automated, protected and secure digital code storage and release software escrow service, without the need to store physical non-online copies of software files (e.g., CD-ROMs, paper documents) in a non-online, non-digital storage facility.

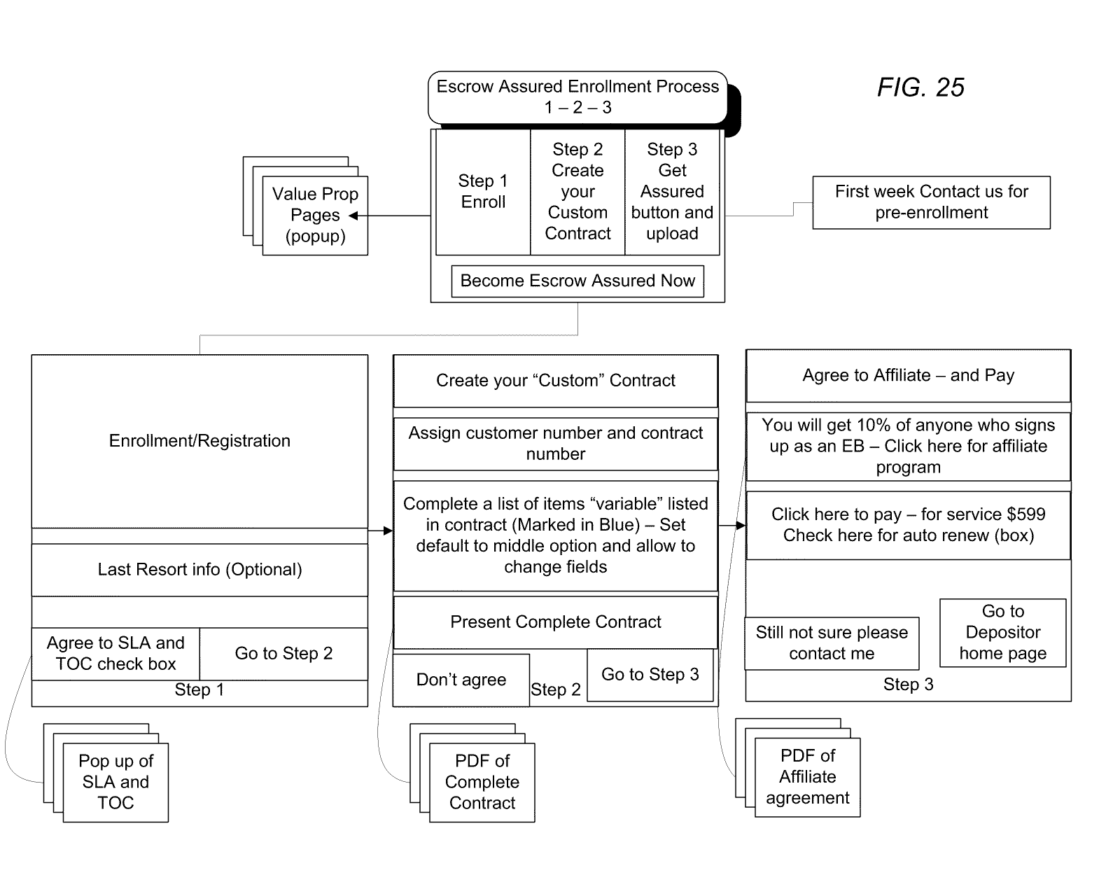

One embodiment of a storage escrow service in accordance with the present invention is further illustrated in FIGS. 25 to 34. FIG. 25 illustrates an enrollment process for a software escrow service, called “Escrow Assured.” In a first step (“Step 1”) the customer (e.g., software developer) defines the basic enrollment/registration information, as well as “last resort” information optionally identifying individuals to be contacted in case the parties to the escrow cannot be located. In a second step (“Step 2”), the developer inputs the terms of a custom contract specifying the conditions for release of the stored digital assets to the counterparty. A customer number is assigned along with a contract number. The developer provides a list of the content items being escrowed, such as code (object or source) files, development documents, data, and the like. The developer can then agree to the terms specified. In a third step (“Step 3”) the developer or other user agrees and makes payment for the service.

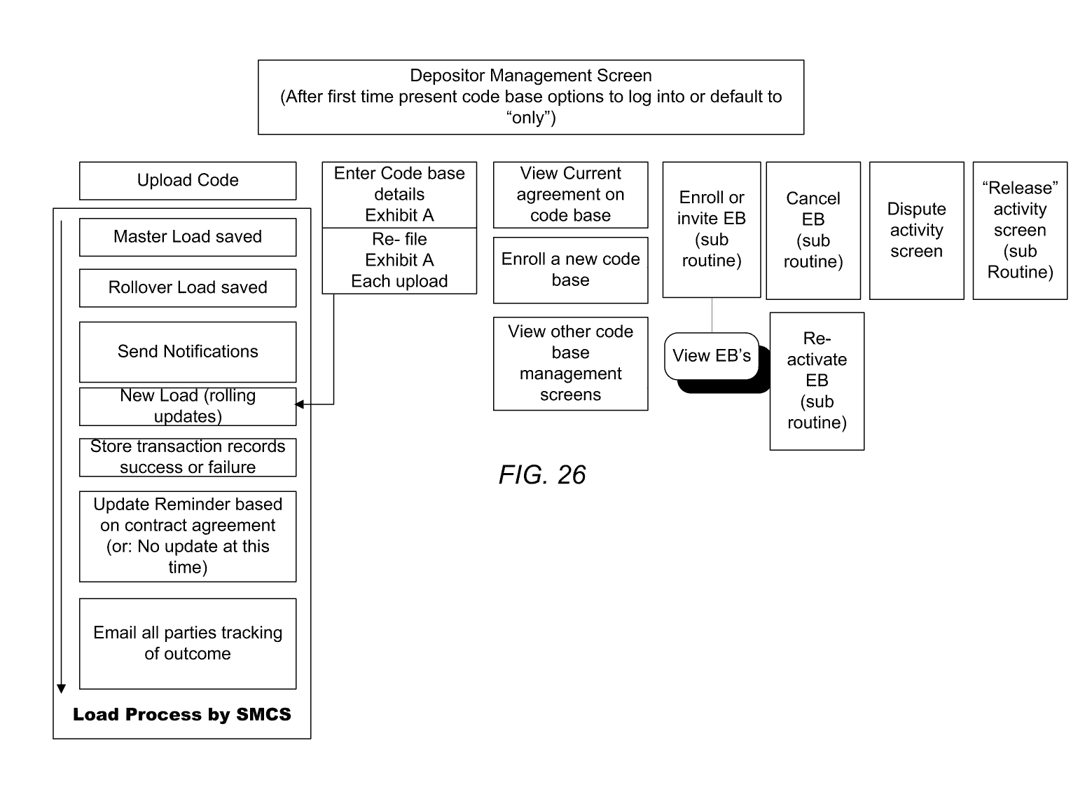

FIG. 26 illustrates the schematic format of a user interface for a Depositor Management Screen, as provided by the services management computer system 100. This user interface enables the developer to upload the digital assets to be escrowed (upload code). The user interface further provides functionality to view the current agreement, enroll additional code base, and view other code base management screens, enroll escrow beneficiaries (“EB”) who will have access to the stored digital assets under the terms of the escrow. The user interface here also provides access to the dispute activity screen by which the developer can see and manage any disputes related to escrowed assets. Also provided is access to a release activity screen by which the developer can see which stored assets have been released from escrow to an EB.

FIG. 26 also illustrates the load process by the services management computer system 100 following the developer uploading code for storage. The services management computer system 100 saves a “Master Load” copy as the golden master copy of the stored assets; this copy is un-modifiable by any party and cannot be downloaded by a party except upon release from the escrow. The services management computer system 100 further saves a rollover load copy as a further backup copy, which is stored in read-only mode, but can downloaded by the developer. The services management computer system 100 sends notifications to the trust company computer system as described above to confirm the storage of the assets. The services management computer system 100 stores transaction records of the loads. The services management computer system 100 updates any reminders for the parties based on the contract for uploading any additional assets or modifications under the contract. The services management computer system 100 sends emails to appropriate parties of the outcome of the saved loads, including the trust company as the escrow agent.

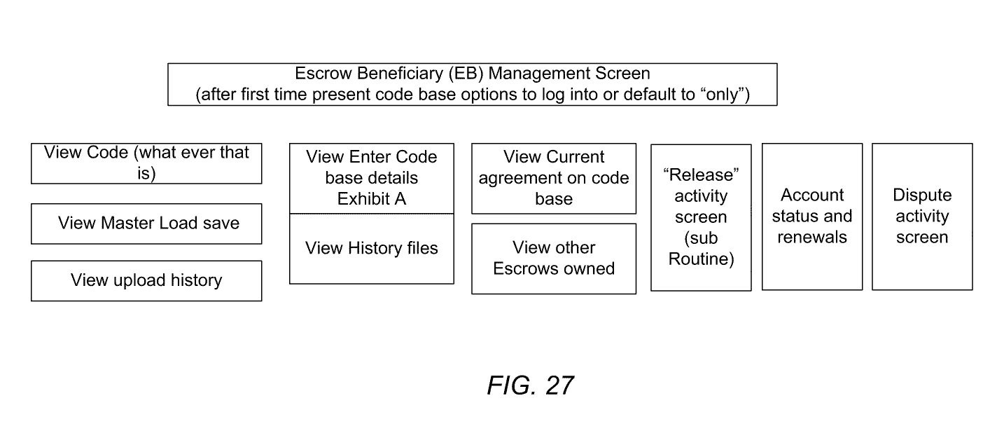

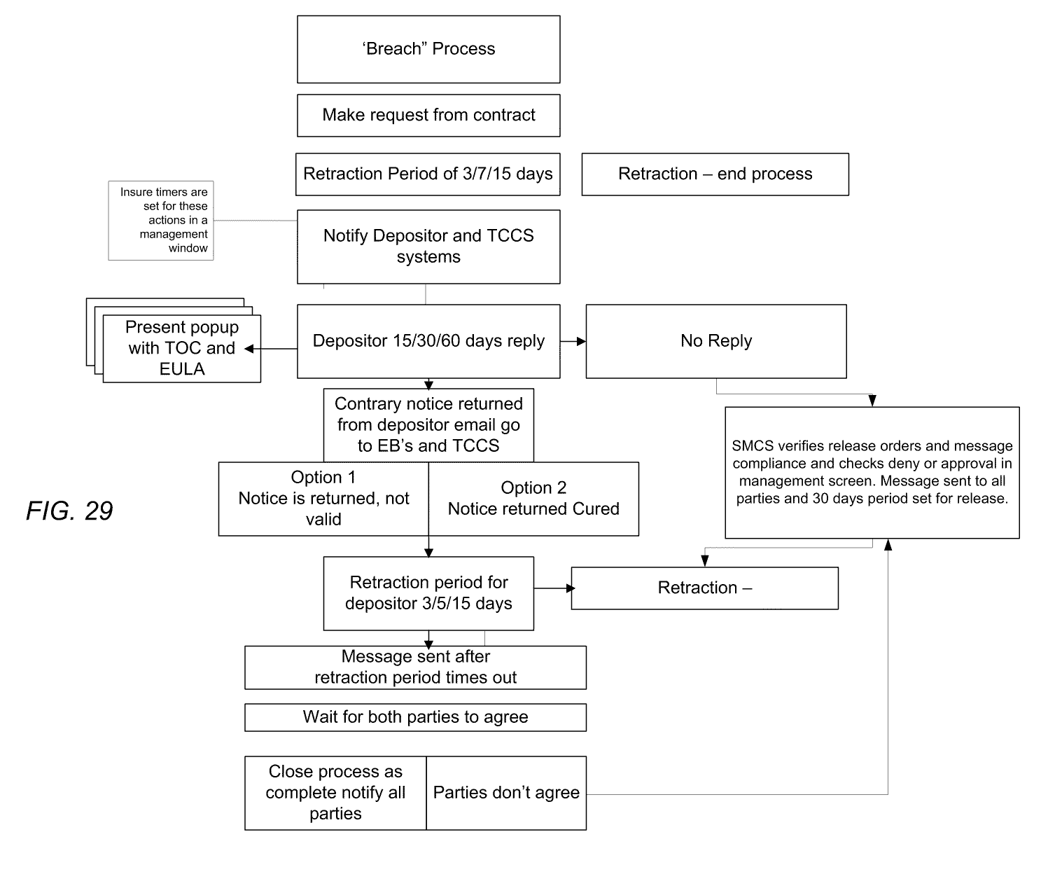

FIG. 27 illustrates the schematic format of a user interface for an Escrow Beneficiary Management Screen, as provided by the services management computer system 100. This user interface enables the EB to view the code that is subject to the escrow, review the Master Load information, and the upload history. The user interface further provides functionality for the EB to view the current agreement, and view other escrows. The user interface here also provides access to the dispute activity screen by which the EB can see and manage (breach process, FIG. 29) any disputes related to escrowed assets. Also provided is access to a release activity screen by which the EB can see which stored assets have been released from escrow. The EB can also review its account status.

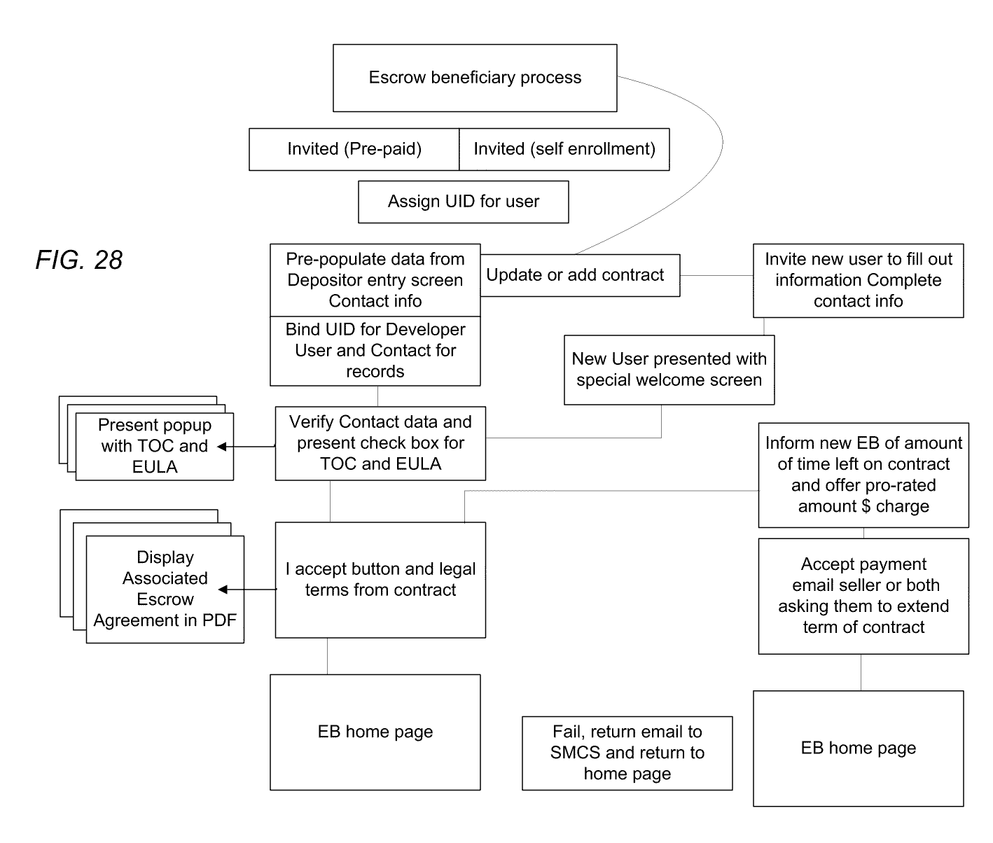

FIG. 28 illustrates the basic flow for the escrow beneficiary enrollment process, provided by the service management computer system 100 by which an EB enrolls in the system for an escrow.

FIG. 29 illustrates a breach process provided by the service management computer system 100 by which an EB can initiate a dispute pertaining a breach of contract with respect to an escrowed item; the system 100 provides this process in an automated fashion, including receiving inputs from the various parties, and providing communications thereto. The EB makes a request for a dispute. A retraction period of three, seven or fifteen days is initiated (as per the contract), during which the EB can retract the dispute. If the retraction is made, the process is ended. If the retraction is not made, then the service management computer system 100 notifies the depositor (e.g. developer) and the trust company computer systems of the dispute. The service management computer system 100 also freezes the escrowed assets so that neither party has access. The depositor has a fixed time period (e.g., 15, 30, or 60 days) to reply. The service management computer system 100 provides popup windows with the terms and condition and EULA for the dispute as well. If the depository does not reply within the time period, then the service management computer system 100 verifies a release order (e.g., as received from a legal body such as a court, mediation, or arbitration panel), and notifies the parties of scheduled release of the escrowed content. If the depositor provides a contrary notice (i.e., disputing the breach of contract), the service management company then waits for either information from a legal body that the depositor's notice is not valid (“option 1”) or the that breach is cured (“option 2”). Another retraction period is initiated. After the retraction period, the service management computer system 100 notifies the parties of the current state of the dispute and waits for the parties to agree to the outcome. If the parties are in agreement, the no action is taken, and the process is terminated. If the parties are not in agreement, the service management computer system 100 verifies any release orders and notifies the parties of the schedule release.

The process illustrated in FIG. 29 also allows for the developer (depositor) to initiate a dispute in order to remove a party as an escrow beneficiary.

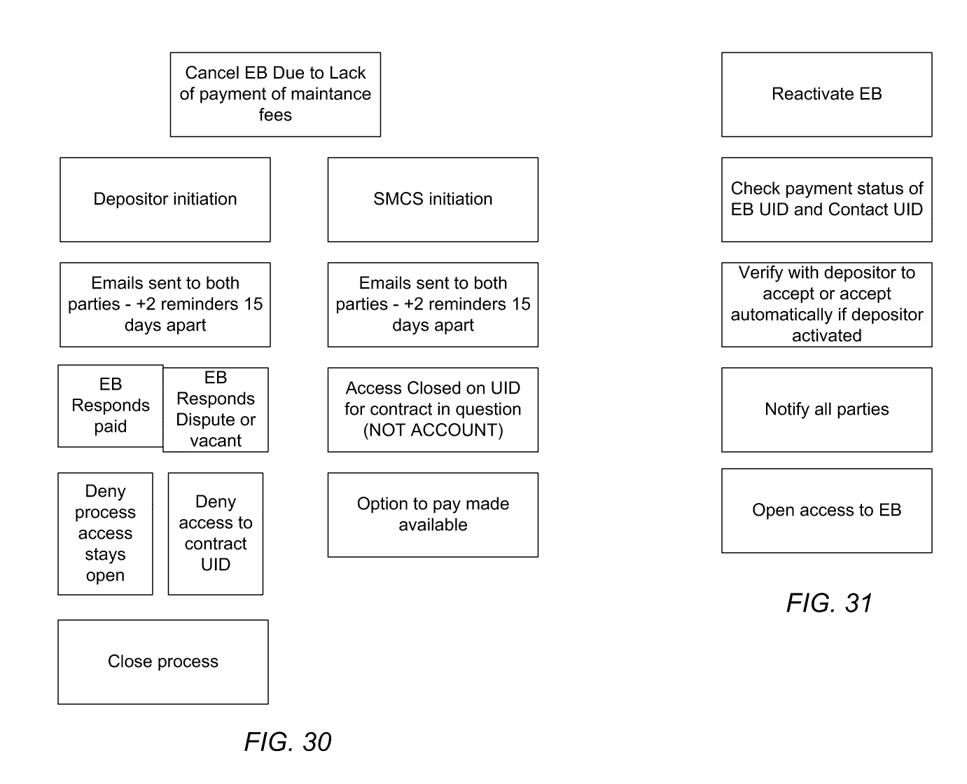

FIG. 30 illustrates process flows undertaken by the service management computer system 100 for cancellation of an EB due to lack of payment of maintenance fees for the escrow service; termination can be initiated by either a depositor or the service management computer system 100. FIG. 31 illustrates the process flow for reactivation of an EB following cancellation.

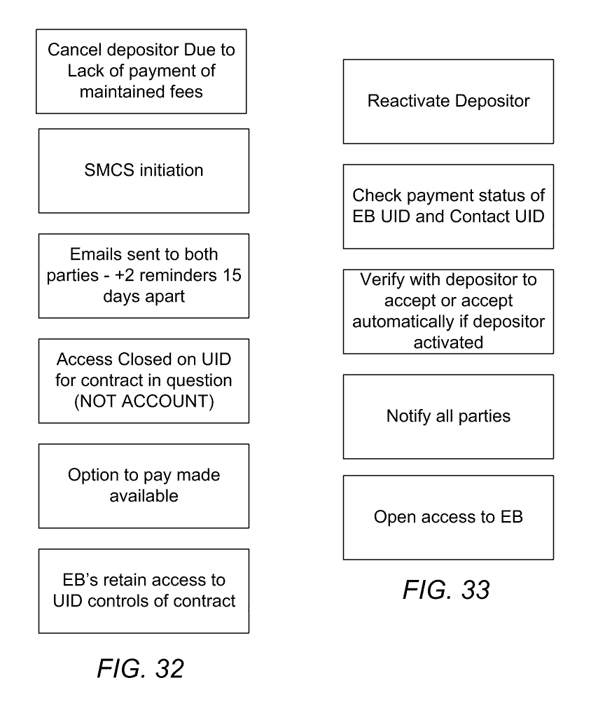

FIG. 32 illustrates a process flow undertaken by the service management computer system 100 for cancellation of a depositor due to lack of payment of maintenance fees for the escrow service; termination here is initiated by the service management computer system 100. FIG. 33 illustrates the process flow for reactivation of a depositor following cancellation.

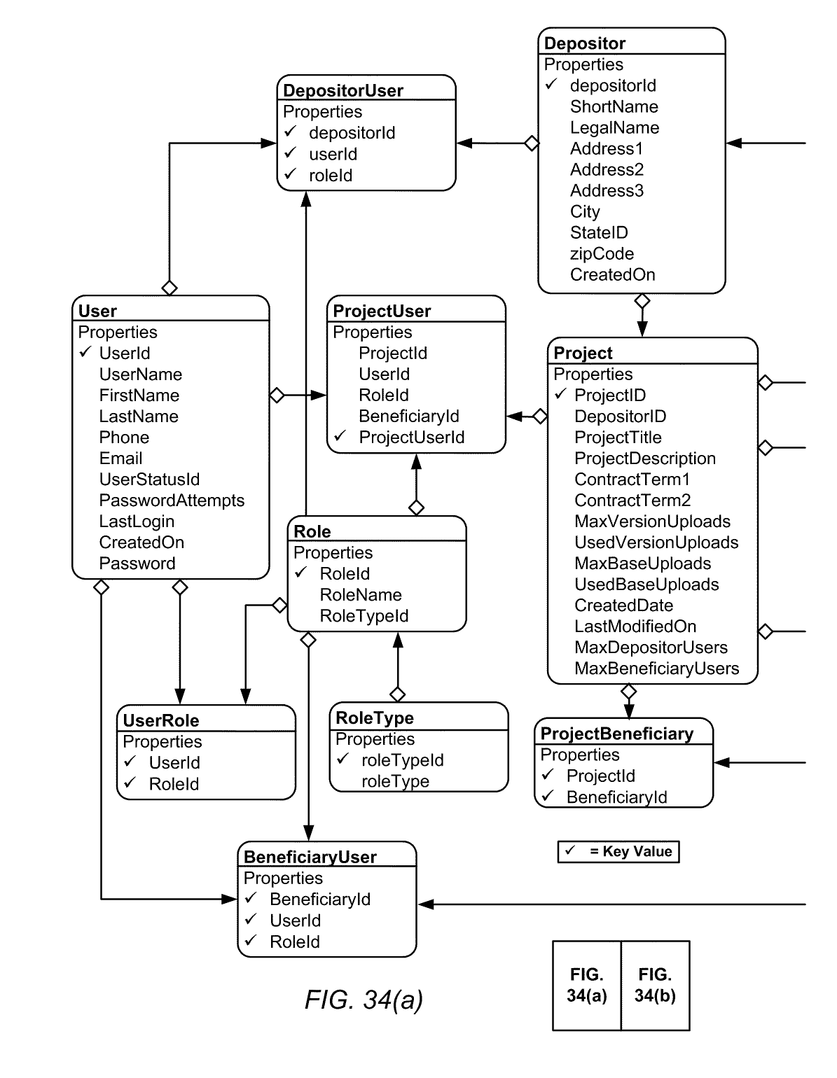

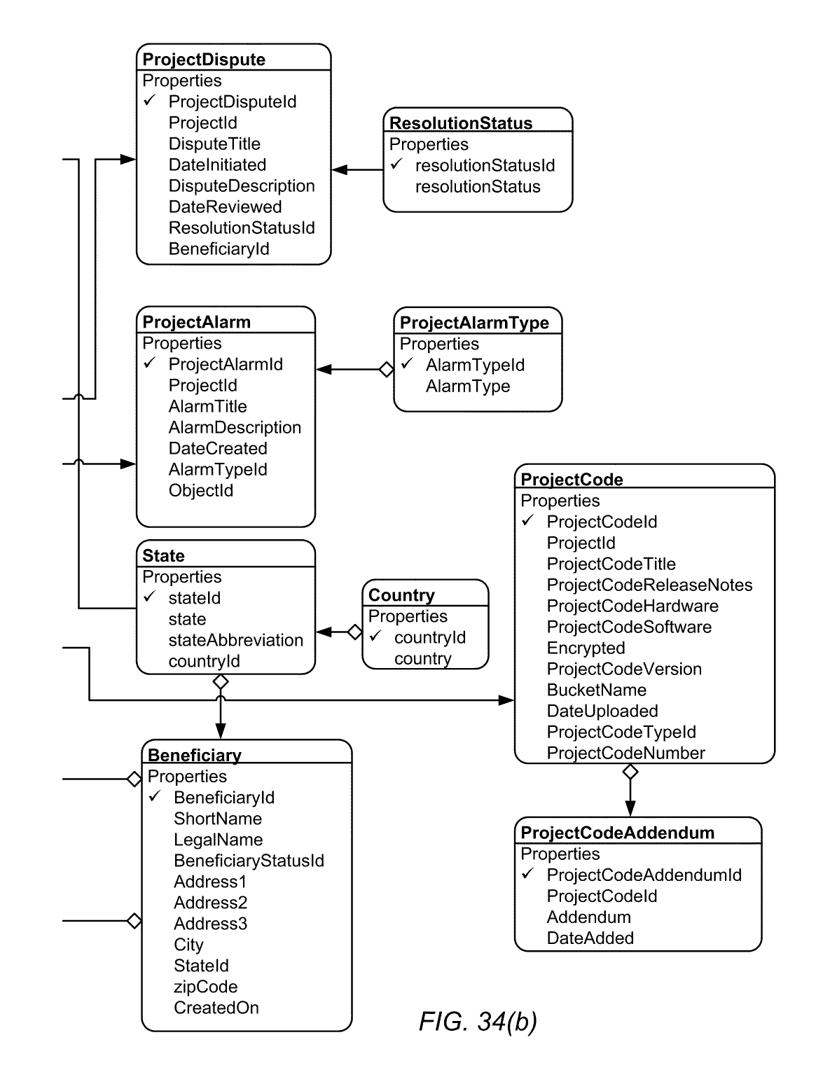

FIG. 34 illustrate a basic class diagram of the classes used in the service management computer system 100 for implementation of a software escrow service.

The present invention has been described in particular detail with respect to one possible embodiment. Those of skill in the art will appreciate that the invention may be practiced in other embodiments. First, the particular naming of the components, capitalization of terms, the attributes, data structures, or any other programming or structural aspect is not mandatory or significant, and the mechanisms that implement the invention or its features may have different names, formats, or protocols. Further, the system may be implemented via a combination of hardware and software, as described, or entirely in hardware elements. Also, the particular division of functionality between the various system components described herein is merely exemplary, and not mandatory; functions performed by a single system component may instead be performed by multiple components, and functions performed by multiple components may instead performed by a single component.

Some portions of above description present the features of the present invention in terms of algorithms and symbolic representations of operations on information. These algorithmic descriptions and representations are the means used by those skilled in the data processing arts to most effectively convey the substance of their work to others skilled in the art. These operations, while described functionally or logically, are understood to be implemented by computer programs. Furthermore, it has also proven convenient at times, to refer to these arrangements of operations as modules or by functional names, without loss of generality.

Unless specifically stated otherwise as apparent from the above discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system memories or registers or other such information storage, transmission or display devices.

Certain aspects of the present invention include process steps and instructions described herein in the form of an algorithm. It should be noted that the process steps and instructions of the present invention could be embodied in software, firmware or hardware, and when embodied in software, could be downloaded to reside on and be operated from different platforms used by real time network operating systems.

The present invention also relates to an apparatus for performing the operations herein. This apparatus may be specially constructed for the required purposes, or it may comprise a general-purpose computer selectively activated or reconfigured by a computer program stored on a computer readable medium that can be accessed by the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs), EPROMs, 12PROMs, magnetic or optical cards, application specific integrated circuits (ASICs), or any type of media suitable for storing electronic instructions, and each coupled to a computer system bus. Furthermore, the computers referred to in the specification may include a single processor or may be architectures employing multiple processor designs for increased computing capability.

The algorithms and operations presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will be apparent to those of skill in the, along with equivalent variations. In addition, the present invention is not described with reference to any particular programming language. It is appreciated that a variety of programming languages may be used to implement the teachings of the present invention as described herein, and any references to specific languages are provided for disclosure of enablement and best mode of the present invention.

The present invention is well suited to a wide variety of computer network systems over numerous topologies. Within this field, the configuration and management of large networks comprise storage devices and computers that are communicatively coupled to dissimilar computers and storage devices over a network, such as the Internet.

Finally, it should be noted that the language used in the specification has been principally selected for readability and instructional purposes, and may not have been selected to delineate or circumscribe the inventive subject matter. Accordingly, the disclosure of the present invention is intended to be illustrative, but not limiting, of the scope of the invention, which is set forth in the following claims.

1. A computer implemented system for providing an online digital asset escrow services, comprising:
a services management computer system operated by a services management company, the services management computer system configured to provide a programmatic interface by which a customer can enter into a customer service agreement with the services management company via a customer computer system to purchase a selected allotment of digital storage by the customer, and to store in the selected allotment customer-provided digital assets in escrow for an escrow beneficiary selected by the customer; and
a trust company computer system operated by trust company, wherein
the trust company operates a trust for the services management company, by which the trust is obligated to the services management company and the customer to ensure that the customer-provided digital asserts stored in the selected allotment of digital storage are maintained in perpetuity for the customer and the escrow beneficiary.
